(19) United States
(12) Patent Application Publication
(10) Pub. No.: US 2025/0034370 A1
(43) Pub. Date: Jan. 30, 2025

(54) TIRE

(71) Applicant: SUMITOMO RUBBER INDUSTRIES, LTD., Kobe-shi (JP)

(72) Inventor: Kentaro NAKAMURA, Kobe-shi (JP)

(73) Assignee: SUMITOMO RUBBER INDUSTRIES, LTD., Kobe-shi (JP)

(21) Appl. No.: 18/764,542

(22) Filed: Jul. 5, 2024

(30) Foreign Application Priority Data
Jul. 27, 2023 (JP) 2023-122782
May 17, 2024 (JP) 2024-080989

(51) Int. Cl. C08L 9/00; B60C 1/00; B60C 11/03; B60C 11/12; C08K 3/36

(52) U.S. Cl. CPC C08L 9/00; B60C 1/0016; B60C 11/1272; C08K 3/36; B60C 2011/0341; B60C 2011/1277; C08L 2205/02

(57) ABSTRACT

It is an object of the present invention to provide a tire that can achieve both wet grip performance and abrasion resistance. Provided is a pneumatic tire comprising a tread part, wherein the tread part is composed of a rubber composition comprising 50 parts by mass or more of silica based on 100 parts by mass of a rubber component, wherein the rubber component comprises 80% by mass or more of a butadiene rubber, and wherein, when A_{BR} represents a content, in % by mass, of the butadiene rubber in the rubber component and L represents a land ratio, in %, of a tread surface of the tread part, A_{BR} and L satisfy the following inequality:

$${A}_{BR} \times L > 4800. \qquad ( 1 )$$

### CROSS-REFERENCE TO RELATED APPLICATIONS

This application claims priorities to JP Application No. 2023-122782, filed Jul. 27, 2023 and JP Application No. 2024-080989, filed May 17, 2024, the disclosures of which are expressly incorporated herein by reference in its entirety.

### TECHNICAL FIELD

The present invention relates to a tire.

### BACKGROUND OF THE INVENTION

Various methods of improving wet grip performance and abrasion resistance have been studied so far. For example, JP 2017-141405 A discloses a rubber composition for tire comprising a diene-based rubber (A) that comprises a predetermined amount of a specific conjugated diene-based rubber represented by a predetermined formula, silica whose CTAB adsorption specific surface area is within a predetermined range, and a silane coupling agent represented by a predetermined formula, and a pneumatic tire using the rubber composition for tire in a tire tread.

### SUMMARY OF THE INVENTION

However, since wet grip performance and abrasion resistance basically contradict each other, it is difficult to improve both performances at the same time, and thus, further improvements have been required for achieving both performances.

It is an object of the present invention to provide a tire that can achieve both wet grip performance and abrasion resistance.

The present invention relates to a tire below:

A pneumatic tire comprising a tread part,
wherein the tread part is composed of a rubber composition comprising 50 parts by mass or more of silica based on 100 parts by mass of a rubber component,
wherein the rubber component comprises 80% by mass or more of a butadiene rubber, and
wherein, when A_{BR} represents a content, in % by mass, of the butadiene rubber in the rubber component and L represents a land ratio, in %, of a tread surface of the tread part, A_{BR} and L satisfy the following inequality:

$${A}_{BR} \times L > 4800. \qquad ( 1 )$$

According to the present invention, a tire that can achieve both wet grip performance and abrasion resistance can be provided.

### BRIEF DESCRIPTION OF THE DRAWINGS

FIG. 1 is a view schematically representing a total ground-contacting area of a tread surface.

FIG. 2 is a view showing a thickness of a tread part in a cross section of a tire taken along a plane passing through a tire rotation axis.

FIG. 3 is a developed view of a part of a tread of a tire having small holes in shoulder regions.

FIG. 4 is a developed view of a part of a tread of a tire having circumferential narrow grooves in shoulder regions.

FIG. 5 is a developed view of a part of a tread of a tire having widened circumferential grooves in land parts closest to a tire center line.

FIG. 6 is a view representing a cross section of the widened circumferential groove in FIG. 5 taken along a plane passing through a tire rotation axis.

### DETAILED DESCRIPTION

The tire that is one embodiment of the present invention is a pneumatic tire comprising a tread part, wherein the tread part is composed of a rubber composition comprising 50 parts by mass or more of silica based on 100 parts by mass of a rubber component, wherein the rubber component comprises 80% by mass or more of a butadiene rubber, and wherein, when A_{BR} represents a content, in % by mass, of the butadiene rubber in the rubber component and L represents a land ratio, in %, of a tread surface of the tread part, A_{BR} and L satisfy the following inequality:

$${A}_{BR} \times L > 4800. \qquad ( 1 )$$

Although it is not intended to be bound by theory, in the present invention, the following can be considered as a mechanism by which both wet grip performance and abrasion resistance can be achieved.

That is, (1) in the rubber composition constituting the tread part, abrasion resistance is improved by using a butadiene rubber as a main polymer of the rubber component, and (2) followability to a road surface of the tread part is improved by comprising a certain amount or more of silica, thereby improving wet grip performance, and (3) a ground-contacting area is increased by keeping the land ratio of the tread surface large, thereby dispersing an abrasion energy input from the road surface to the tread surface, so that it is considered that abrasion of the tread can be suppressed. It is considered that, with cooperation of (1) to (3), both wet grip performance and abrasion resistance can be achieved.

When T represents a thickness, in mm, of the tread part, A_{BR}, L, and T preferably satisfy the following inequality:

$$( {A}_{BR} / T ) \times L > 400. \qquad ( 2 )$$

The smaller the thickness of the tread part is, the more the rigidity of the tread part improves, which is thus considered to work favorably for both wet grip performance and abrasion resistance.

It is preferable that the rubber composition comprises at least one type of hydrocarbon resin and that a content of the hydrocarbon resin is 5% by mass or more.

It is considered that further combining a certain amount or more of hydrocarbon resin works favorably for both wet grip performance and abrasion resistance.

A content of the silica based on 100 parts by mass of the rubber component is preferably 100 parts by mass or more.

It is considered that followability to a road surface of the tread part derived from the silica further improves and wet grip performance improves.

The butadiene rubber preferably comprises a modified butadiene rubber.

It is considered that dispersibility of the silica in the rubber improves by a function of the modified butadiene rubber, and followability to a road surface of the tread surface further improves, which works favorably for wet grip performance.

The right side of the inequality (1) is preferably 4950, more preferably 6000.

It is considered that improvement of abrasion resistance can be expected by increasing a product of a content of the butadiene rubber and a land ratio.

A content, A_{BR}, of the butadiene rubber in the rubber component is preferably greater than 85% by mass.

It is considered that further improvement of abrasion resistance due to the butadiene rubber can be expected.

The rubber component preferably comprises a styrene-butadiene rubber having a styrene content of less than 25% by mass or an isoprene-based rubber.

It is considered that, when the rubber component comprises a styrene-butadiene rubber having a low styrene content, it is easily rendered compatible with the butadiene rubber, so that the butadiene rubber can be effectively reinforced, and when the rubber component comprises an isoprene-based rubber, the isoprene rubber encapsulates silica, which is dispersed as a minute domain in the butadiene rubber, so that followability to a road surface increases and wet grip performance improves.

The tread surface has two or more circumferential main grooves extending in a tire circumferential direction and land parts partitioned off by the circumferential main grooves, and when a pair of land parts located on an outermost side in a tire width direction of the land parts are defined as shoulder land parts, the shoulder land part preferably has one or more small holes each having an opening area of greater than 0.1 mm² and less than 15 mm².

Since the small holes contribute to improvement of drainage performance, drainage performance in a shoulder region improves, so that it is considered that wet grip performance improves.

The tread surface has two or more circumferential main grooves extending in the tire circumferential direction and land parts partitioned off by the circumferential main grooves, and when a pair of land parts located on the outermost side in the tire width direction of the land parts are defined as shoulder land parts, the shoulder land part preferably has at least one or more circumferential narrow grooves.

Since the circumferential narrow grooves contribute to improvement of drainage performance, drainage performance in the shoulder region improves, so that it is considered that wet grip performance improves.

The tread surface preferably has widened circumferential grooves whose groove width widens towards the inner side in the tire radial direction.

Since the width of the widened circumferential groove enlarges as the tread part abrades, drainage performance after the tire abrasion improves, so that it is considered that wet grip performance improves.

The widened circumferential groove is preferably present on a land part located on a tire center line, or on a land part closest to the tire center line when a circumferential main groove is present on the tire center line.

It is considered that drainage performance after the tire abrasion at a central part in the tire width direction improves, so that wet grip performance improves.

### Definitions

A “standardized state” is a state where a tire is rim-assembled on a standardized rim and a standardized internal pressure is filled, and no load is applied.

A “dimension of each part of the tire” is a value specified in a standardized condition for one appearing on the outer surface of the tire, unless otherwise specified, while it is a value specified in a condition where the tire is cut on a plane including a tire rotation axis and the cut tire piece is held to a rim width of a standardized rim for one present inside the tire.

A “standardized rim” is a rim in a standard system including a standard on which the tire is based, defined for each tire by the standard. For example, the “standardized rim” refers to a standard rim of an applicable size described in “Jatma Year Book” in JATMA (The Japan Automobile Tyre Manufacturers Association, Inc.), “Measuring Rim” described in “STANDARDS MANUAL” in ETRTO (The European Tyre and Rim Technical Organisation), or “Design Rim” described in “YEAR BOOK” in TRA (The Tire and Rim Association, Inc.), to which references are made in this order, and if there is an applicable size at the time of the reference, the rim conforms to its standard. Besides, in a case of tires that are not defined by the standard, the “standardized rim” shall refer to a rim that can be assembled and maintain an internal pressure, that is, one that has the smallest rim diameter and secondly has the narrowest rim width, among rims that do not cause air leakage between the rim and the tire.

A “standardized internal pressure” is an air pressure in a standard system including a standard on which the tire is based, defined for each tire by the standard, for example, it refers to a “MAXIMUM AIR PRESSURE” in JATMA, “INFLATION PRESSURE” in ETRTO, or a maximum value described in Table “TIRE LOAD LIMITS AT VARIOUS COLD INFLATION PRESSURES” in TRA, to which references are made in this order as in the case of the standardized rim, and if there is an applicable size at the time of the reference, the standardized internal pressure conforms to its standard. Besides, in the case of tires that are not defined by the standard, the standardized internal pressure shall refer to a standardized internal pressure (250 KPa or more) of another tire size (specified in the standard) for which the standardized rim is described as a standard rim, and when a plurality of standardized internal pressures of 250 KPa or more are described, it shall refer to the minimum value among them.

A “standardized load” is a load in a standard system including a standard on which the tire is based, defined for each tire by the standard, for example, a “MAXIMUM LOAD CAPACITY” in JATMA, a “LOAD CAPACITY” in ETRTO, or a maximum value described in Table “TIRE LOAD LIMITS AT VARIOUS COLD INFLATION PRESSURES” in TRA, to which references are made in this order as in cases of a standardized rim and a standardized internal pressure, and if there is an applicable size at the time of the reference, the load conforms to its standard. Then, in the case of tires that are not defined by the standard, a standardized load WL is calculated by the following equations. Besides, in the present specification, the “maximum load capacity” has the same meaning as the above-described standardized load.

$${W}_{L} = 0.000011 \times V + 175 \\ V = \{ {( Dt / 2 )}^{2} - {( Dt / 2 - Ht )}^{2} \} \times π \times Wt$$

V: Virtual volume of tire (mm³)
Dt: Tire outer diameter Dt (mm)
Ht: Tire cross-sectional height (mm)
Wt: Tire cross-sectional width (mm)

A “land ratio L (%)” is calculated from a total ground-contacting area and an effective ground-contacting area of a tire by the following equation:

$$Land ratio L ( \% ) = ( effective ground - contacting area / total ground - contacting area ) \times 100.$$

The “total ground-contacting area” is an area of a tread region as obtained from a contour when a tire is pressed against the ground. The total ground-contacting area can be obtained by mounting a tire on a standardized rim, applying a standardized internal pressure, and leaving the tire to stand at 25° C. for 24 hours, followed by painting the tire tread surface with ink, applying a standardized load (the maximum load capacity) on the tire to press the tire vertically against a cardboard (a camber angle at) 0°, and transferring the ink. The total ground-contacting area is determined as an average value of five areas obtained by performing the above-described transferring operation at a total of five locations by rotating a tire by 72°.

The “effective ground-contacting area” is an area of a tread region where a tire touches the ground when the tire is pressed against the ground. The effective ground-contacting area can be obtained by mounting a tire on a standardized rim, applying a standardized internal pressure, and leaving the tire to stand at 25° C. for 24 hours, followed by painting the tire tread surface with ink, applying a standardized load (the maximum load capacity) on the tire to press the tire vertically against a cardboard (a camber angle at) 0°, and transferring the ink. The effective ground-contacting area is determined as an average value of five areas obtained by performing the above-described transferring operation at a total of five locations by rotating a tire by 72°.

The “thickness T, in mm, of the tread part” is a thickness of a rubber layer constituting a tread part as measured along a normal line on a tire equator in a cross section of a tire taken along a plane including a tire rotation axis. When the tread part consists of a plurality of rubber layers, the thickness is a sum of thicknesses of all the rubber layers. If a circumferential groove is present on the tire equator, measurement is taken along the normal line on an outermost surface end of the tire, closer to the tire equator, of outermost surface ends of the tire on a groove wall of the circumferential groove. Moreover, if a rubber member different from the tread part, such as an electrically conductive member and the like, is present on the tire equatorial plane, measurement is taken along the normal line on an outermost surface end of the tire, closer to the tire equator, of outermost surface ends of the tire of the tread present on both sides of the rubber member in the tire width direction. The thickness is measured with a tire cut along a plane including a tire rotation axis being held to a standardized rim width. The thickness of the tread part shall be an average value of thicknesses of the tread as calculated at five locations by rotating the tire by 72° in the circumferential direction.

A “content of a hydrocarbon resin” refers to a total content of all of at least one type of hydrocarbon resin contained in a rubber composition.

A “content of a plasticizing agent” also includes an amount of a plasticizing agent in a rubber component extended by the plasticizing agent. Similarly, an “oil content” also includes an amount of oil contained in the oil-extended rubber.

A “circumferential main groove” refers to a circumferential groove having a groove width of 4 mm or more in a tire width direction on a tread surface, of circumferential grooves extending continuously in a tire circumferential direction. The circumferential main groove may extend linearly along the circumferential direction or may extend in a wavy, sinusoidal, or zigzag shape along the circumferential direction. However, widened circumferential grooves which will be described later are not included.

A “land part” is a region on a tread surface defined by a circumferential main groove, which is a part where a tire touches a road surface. Among land parts, a pair of land parts located on the outermost side in the tire width direction is referred to as shoulder land parts, and a land part present in a region sandwiched by the shoulder land parts is referred to as a center land part. When there is one circumferential main groove, only shoulder land parts are present and no center land part is present.

A “small hole” is a small hole present on a tread surface, which extends from an inside of a tread and opens into the tread surface. Small holes exist independently and do not communicate with circumferential grooves, lateral grooves, and the like.

A “circumferential narrow groove” refers to a circumferential groove having a groove width of less than 4 mm in a tire width direction on a tread surface, of circumferential grooves extending continuously in a tire circumferential direction. The circumferential narrow groove may extend linearly along the circumferential direction or may extend in a wavy, sinusoidal, or zigzag shape along the circumferential direction. However, widened circumferential grooves which will be described later are not included.

A “widened circumferential groove” is a groove configured such that a groove width in a tire width direction is the minimum on a tread surface and widens towards an inner side in a tire radial direction, among circumferential grooves extending continuously in a tire circumferential direction. The widened circumferential groove may extend linearly along the circumferential direction or may extend in a wavy, sinusoidal, or zigzag shape along the circumferential direction.

A “total styrene content (% by mass)” is a total content of styrene parts comprised in a total amount of rubber components, which can be calculated by Σ(styrene content (% by mass) in each rubber component×content (% by mass) of each rubber component in total amount of rubber components/100). For example, when 100% by mass of a rubber component consists of 85% by mass of a styrene-butadiene rubber with 40% by mass of a styrene content, 5% by mass of a styrene-butadiene rubber with 25% by mass of a styrene content, and 10% by mass of a butadiene rubber with 0% by mass of a styrene content, a total styrene amount in the rubber component is 35.25% by mass (=40×85/100+25×5/100+0×10/100).

### [Measuring Methods]

A “styrene content (% by mass)” is calculated by ¹H-NMR measurement.

A “vinyl content (1,2-bond butadiene unit amount) (mol %)” is calculated by infrared absorption spectrometry according to JIS K 6239-2:2017.

A “cis content (cis-1,4-bond butadiene unit amount) (mol %)” is calculated by infrared absorption spectrometry according to JIS K 6239-2:2017.

A “glass transition temperature (Tg) (C)” is measured by measurement while raising temperature at a temperature rising rate of 10° C./min using a differential scanning calorimeter (Q200) manufactured by TA Instruments Japan Inc. according to JIS K 7121. In the present invention, in particular, a Tg of each of a styrene-butadiene rubber, a butadiene rubber, and the like is measured.

A “glass transition temperature (Tg) of a rubber composition” is a temperature corresponding to a maximum value (tan 0 peak temperature) within a range of −60° C. or more and 40° C. or less in a temperature distribution curve of tan δ obtained by measurement, under a condition of a frequency of 10 Hz, an initial strain of 10%, a dynamic strain of ±0.5%, and a temperature rising rate at 2° C./min, using a dynamic viscoelasticity measuring device (e.g., EPLEXOR series manufactured by gabo Systemtechnik GmbH). Besides, in the measurement in the range of −60 to 40° C., if the tan δ value continues to gradually increase or decrease as the temperature rises, the glass transition temperature of the rubber composition shall be 40° C. or −60° C., respectively. Moreover, in the range of −60° C. or more and 40° C. or less, if there are two or more points indicating the maximum value, a point having the lowest temperature shall be a glass transition temperature.

A “weight-average molecular weight (Mw)” can be calculated in terms of a standard polystyrene based on measurement values obtained by a gel permeation chromatography (GPC) (e.g., GPC-8000 Series manufactured by Tosoh Corporation, detector: differential refractometer, column: TSKGEL SUPERMULTIPORE HZ-M manufactured by Tosoh Corporation).

A “N₂SA of carbon black” is measured according to JIS K 6217-2:2017.

A “N₂SA of silica” is measured by the BET method according to ASTM D3037-93.

An “average primary particle size” is calculated by an arithmetic mean of particle sizes of 400 particles which are photographed with a transmission or scanning electron microscope. Regarding the particle size, in a case that the particle is in a substantially circular shape, a diameter of the circle is defined as a particle size, in a case that it is in a needle or rod shape, a minor axis is defined as a particle size, and in the other cases, an equivalent circle diameter calculated from an electron microscope image is defined as a particle size. The equivalent circle diameter is calculated as “the positive square root of 4×(area of particle)/TT”. The average primary particle size is applied to silica, carbon black, etc.

A “softening point” is defined as a temperature at which a sphere drops when the softening point specified in JIS K 6220-1:2001 is measured with a ring and ball softening point measuring device.

### [Tire]

The pneumatic tire of the present invention will be described below with reference to the drawings as appropriate. However, the drawings are merely illustrative, and the present invention shall not be interpreted as being limited based on the drawings.

The pneumatic tire of the present invention is a pneumatic tire comprising a tread part, wherein the tread part is composed of a predetermined rubber composition, and wherein, in the rubber composition, when A_{BR} represents a content, in % by mass, of the butadiene rubber in the rubber component and L represents a land ratio, in %, of a tread surface of the tread part, A_{BR} and L satisfy the following inequality (1):

$${A}_{BR} \times L > 4800. \qquad ( 1 )$$

### <Inequality (1)>

In the pneumatic tire of the present invention, a land ratio L, in %, of a tread surface is defined as described above and calculated from a total ground-contacting area and an effective ground-contacting area of the tire.

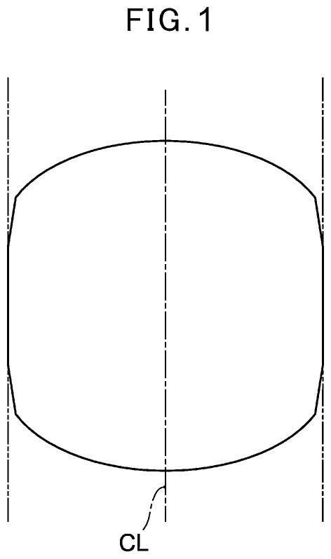

FIG. 1 shows a tread region obtained from a contour of when the tire is pressed against the ground in calculating a total ground-contacting area. As described above, the contour can be obtained by mounting a tire on a standardized rim, applying a standardized internal pressure, and leaving the tire to stand at 25° C. for 24 hours, followed by painting the tire tread surface with ink, applying a standardized load (the maximum load capacity) on the tire to press the tire vertically against a cardboard (a camber angle at) 0°, and transferring the ink. In FIG. 1, CL is a tire center line.

The land ratio is preferably greater than 60%, more preferably greater than 61%, further preferably greater than 62%, further preferably greater than 63%, further preferably greater than 64%, further preferably greater than 65%. Moreover, the land ratio is preferably less than 80%, more preferably less than 75%, further preferably less than 70%.

The right side of the inequality (1) is preferably 4950, more preferably 5300, further preferably 5700, further preferably 6000. On the other hand, an upper limit of the value of A_{BR}×L is not particularly limited, but may be, for example, 7500 or 7000.

### <Inequality (2)>

In the pneumatic tire of the present invention, when T represents a thickness, in mm, of the tread part, A_{BR}, L, and T preferably satisfy the following inequality:

$$( {A}_{BR} / T ) \times L > 400. \qquad ( 2 )$$

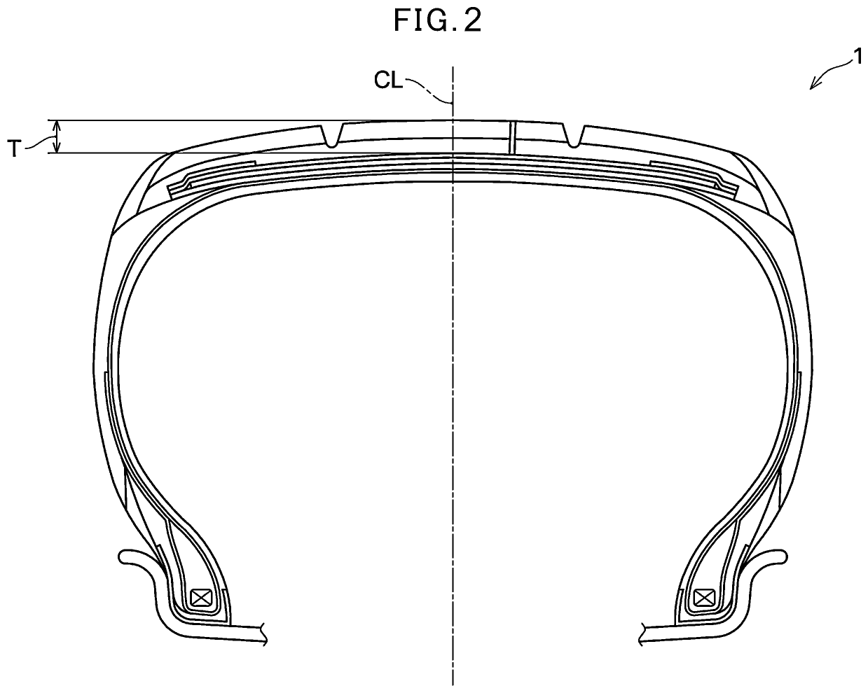

FIG. 2 shows a cross section, taken along a plane passing through a tire rotation axis, of a tire relating to one embodiment of the present invention. CL is a tire center line. In FIG. 2, the tread part comprises a rubber layer constituting a tread surface on an outermost side in a tire radial direction and a rubber layer adjacent to an inner side in the tire radial direction of the rubber layer, and a thickness T of the tread part in this case is a total thickness of thicknesses of these two rubber layers.

The right side of the inequality (2) is preferably 450, more preferably 500, further preferably 550, further preferably 600, further preferably 650. On the other hand, an upper limit of the value of (A_{BR}/T)×L is not particularly limited, but may be, for example, 940, 900, 850, or 800.

### <Small Hole>

In the pneumatic tire of the present invention, it is preferable that the tread surface has two or more circumferential main grooves extending in a tire circumferential direction and land parts partitioned off by the circumferential main grooves, and among the land parts, a pair of land parts located on an outermost side in a tire width direction is referred to as shoulder land parts, the shoulder land parts have one or more small holes each having an opening area of greater than 0.1 mm² and less than 15 mm².

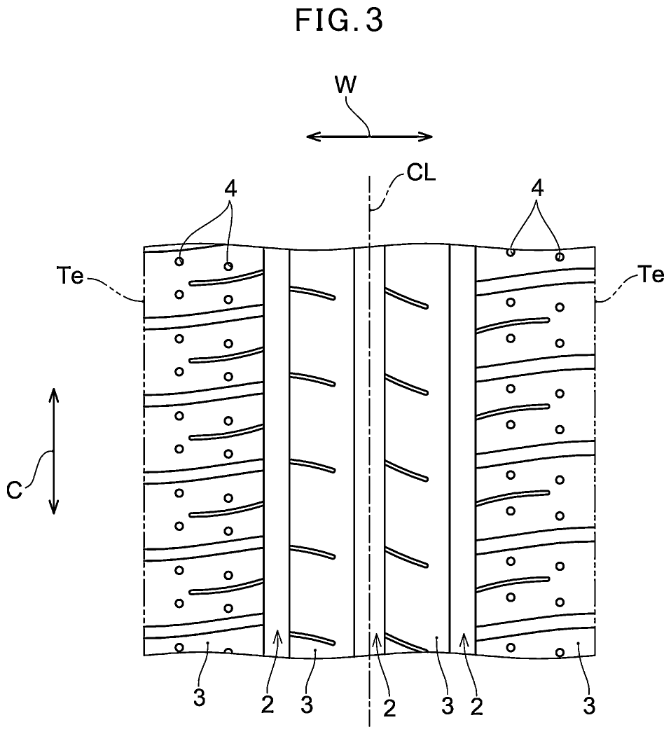

FIG. 3 represents one embodiment in which the pneumatic tire of the present invention has the above-described small holes. In FIG. 3, small holes 4 are formed on the pair of land parts 3 present in the shoulder region of the tread surface. Since the small holes contribute to improvement of drainage performance, drainage performance in the shoulder region improves, contributing improvement of wet grip performance. For example, in actual use, even if a shoulder land part or center land part on one side abrades preferentially and the remaining shoulder land parts harden over time, it is considered that, with the small holes, drainage performance can be secured and wet grip performance after abrasion can be easily improved. The opening area of the small hole to the tread surface is preferably greater than 0.1 mm², more preferably greater than 0.5 mm², further preferably greater than 1.0 mm², particularly preferably greater than 1.5 mm². Moreover, the opening area of the small hole to the tread surface is preferably less than 15 mm², more preferably less than 10 mm², further preferably less than 7.0 mm², particularly preferably less than 5.0 mm². A depth of the deepest part of the small hole is preferably 3% or more, more preferably 5% or more of a depth of the deepest part of the circumferential main groove. Moreover, the depth of the deepest part of the small hole is preferably 80% or less, more preferably 60% or less, further preferably 40% or less of the depth of the deepest part of the circumferential main groove.

### <Circumferential Narrow Groove>

In the pneumatic tire of the present invention, it is preferable that the tread surface has two or more circumferential main grooves extending in the tire circumferential direction and land parts partitioned off by the circumferential main grooves, and when a pair of land parts located on the outermost side in the tire width direction of the land parts are defined as shoulder land parts, the shoulder land parts have at least one or more circumferential narrow grooves.

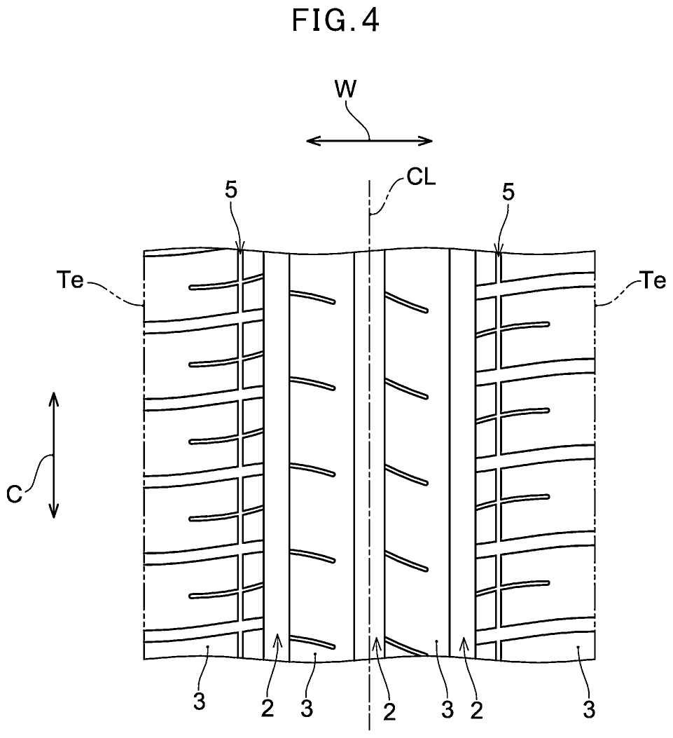

FIG. 4 represents one embodiment in which the pneumatic tire of the present invention has the above-described circumferential narrow grooves. In FIG. 4, circumferential narrow grooves 5 are formed on the pair of land parts 3 present in the shoulder region of the tread surface. Since the circumferential narrow grooves contribute to improvement of drainage performance, drainage performance in the shoulder region improves, contributing improvement of wet grip performance.

### <Widened Circumferential Groove>

In the pneumatic tire of the present invention, the tread surface preferably has widened circumferential grooves whose groove width widens towards the inner side in the tire radial direction.

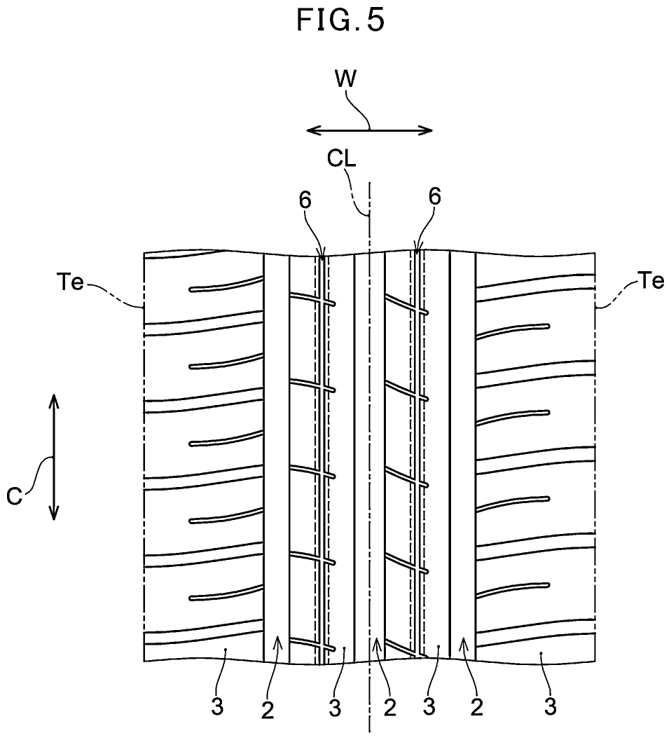

FIG. 5 represents one embodiment in which the pneumatic tire of the present invention has the above-described widened circumferential grooves. In FIG. 5, linear-shaped widened circumferential grooves 6 are formed on two land parts 3 adjacent to a circumferential main groove 2 passing on the tire center line, respectively. The widened circumferential groove may extend, for example, in a wavy, sinusoidal, or zigzag shape along the circumferential direction. Moreover, land parts on which the widened circumferential grooves are formed are not particularly limited, but the widened circumferential grooves are preferably formed on land parts located on the tire center line, or preferably formed on a land part closest to the tire center line, like the widened circumferential grooves 6 in FIG. 5, if a circumferential main groove is present on the tire center line. Besides, the land part closest to the tire center line is a land part where a distance between the end on the inner side of the land part in the tire width direction and the tire center line is the minimum.

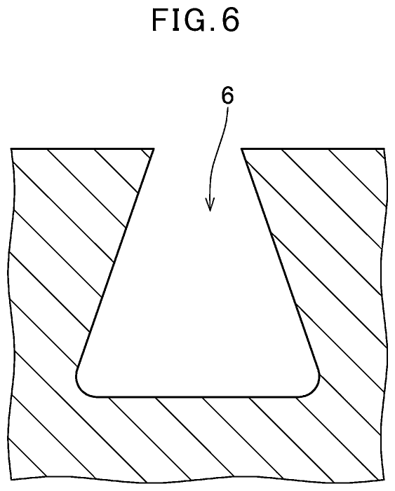

FIG. 6 represents a cross section of the widened circumferential groove 6. In FIG. 6, the groove width of the widened circumferential groove uniformly increases toward the inner side in the tire radial direction, but the increase in groove width is not limited to such an aspect, and the groove width may increase, for example, while repeating small increases and decreases in a curved or stepped shape.

### [Rubber Composition]

The rubber composition constituting the tread part of the pneumatic tire of the present invention will be described below.

The rubber composition relating to the present invention comprises 50 parts by mass or more of silica based on 100 parts by mass of the rubber component.

### <Rubber Component>

The rubber component comprises 80% by mass or more of a butadiene rubber (BR). The BR is preferably a modified butadiene rubber (modified BR).

The rubber component may consist of 100% by mass of a BR, or the rubber component may comprise other rubber components other than a BR, such as an isoprene-based rubber (IR-based rubber), a styrene-butadiene rubber (SBR), and the like. Moreover, the rubber component may comprise an SBR or an IR-based rubber as a rubber component other than a BR or may comprise only an SBR or an IR-based rubber as a rubber component other than a BR. If the rubber component comprises an SBR, the SBR preferably has a styrene content of less than 25% by mass.

### (BR)

The BR is not particularly limited, and those common in the tire industry can be used such as, for example, a BR having a cis content of less than 50 mol % (a low cis BR), a BR having a cis content of greater than 90 mol % (a high cis BR), a rare-earth-based butadiene rubber synthesized using a rare-earth element-based catalyst (a rare-earth-based BR), a BR containing a syndiotactic polybutadiene crystal (an SPB-containing BR), a modified BR (a high cis modified BR, a low cis modified BR), and the like. Examples of the modified BR include BRs modified with similar functional groups and the like as will be explained for an SBR below. The BR may be used alone, or two or more thereof may be used in combination.

As the high cis BR, for example, those commercially available from Zeon Corporation, Ube Industries, Ltd., JSR Corporation, etc. can be used. When the high cis BR is compounded, low temperature characteristics and abrasion resistance can be improved. The cis content is preferably greater than 95 mol %, more preferably greater than 96 mol %, further preferably 97 mol % or more. Besides, in the present specification, the cis content (cis-1,4-bond butadiene unit amount) is a value calculated by infrared absorption spectrometry.

The rare-earth-based BR includes those which are synthesized using a rare-earth element-based catalyst and have a vinyl content of preferably less than 1.8 mol %, more preferably less than 1.6 mol %, further preferably 1.5 mol % or less and a cis content of preferably greater than 95 mol %, more preferably greater than 96 mol %, further preferably 97 mol % or more. As the rare-earth-based BR, for example, those commercially available from LANXESS, etc. can be used.

Examples of the SPB-containing BR include those in which 1,2-syndiotactic polybutadiene crystal is chemically bonded with BR and dispersed, but not those in which the crystal is simply dispersed in the BR. As such an SPB-containing BR, those commercially available from Ube Industries, Ltd., etc. can be used.

As the modified BR, a modified butadiene rubber (modified BR) modified at its terminal and/or main chain with a functional group comprising at least one element selected from the group consisting of silicon, nitrogen, and oxygen can be appropriately used.

Examples of other modified BRs include those obtained by adding a tin compound after polymerizing 1,3-butadiene by a lithium initiator, the end of which is further bonded by tin-carbon bond (tin-modified BR), and the like. Moreover, the modified BR may be either non-hydrogenated or hydrogenated.

A weight-average molecular weight (Mw) of the BR is preferably greater than 300,000, more preferably greater than 350,000, further preferably greater than 400,000, from the viewpoint of abrasion resistance. Moreover, it is preferably less than 2,000,000, more preferably less than 1,000,000, further preferably less than 500,000, from the viewpoints of cross-linking uniformity, etc. Besides, the Mw can be calculated by the above-described measuring method.

The rubber component relating to the present invention comprises 80% by mass or more of a BR. A content, A_{BR}, of the BR in the rubber component is preferably greater than 83% by mass, more preferably greater than 85% by mass, further preferably 90% by mass or more, from the viewpoint of abrasion resistance. Moreover, A_{BR} may be 100% by mass. On the other hand, A_{BR} is preferably less than 95% by mass, more preferably less than 93% by mass, further preferably less than 90% by mass, from the viewpoint of wet grip performance.

### (Other Rubber Components)

As the rubber components relating to the present invention, rubber components other than the above-described BRs may be compounded. As other rubber components, cross-linkable rubber components commonly used in the tire industry can be used, such as, for example, an isoprene-based rubber (IR-based rubber), a styrene-butadiene rubber (SBR), a styrene-isoprene-butadiene copolymer rubber (SIBR), a styrene-isobutylene-styrene block copolymer (SIBS), a chloroprene rubber (CR), an acrylonitrile-butadiene rubber (NBR), a hydrogenated nitrile rubber (HNBR), a butyl rubber (IIR), an ethylene propylene rubber, a polynorbornene rubber, a silicone rubber, a polyethylene chloride rubber, a fluororubber (FKM), an acrylic rubber (ACM), a hydrin rubber, and the like. Other rubber components may be used alone, or two or more thereof may be used in combination.

### <<SBR>>

The SBR is not particularly limited, examples of which include a solution-polymerized SBR (S-SBR), an emulsion-polymerized SBR (E-SBR), modified SBRs (a modified S-SBR, a modified E-SBR) thereof, and the like. Examples of the modified SBR include an SBR modified at its terminal and/or main chain, a modified SBR coupled with tin, a silicon compound, etc. (a modified SBR of condensate or having a branched structure, etc.), and the like. Among them, an S-SBR and a modified SBR are preferable. Furthermore, hydrogenated ones of these SBRs (hydrogenated SBRs) and the like can also be used. The SBR may be used alone, or two or more thereof may be used in combination.

Examples of the S-SBR that can be used in the present invention include S-SBRs manufactured and sold by JSR Corporation, Sumitomo Chemical Co., Ltd., Ube Industries, Ltd., Asahi Kasei Corporation, ZS Elastomer Co., Ltd., etc.

A styrene content of an SBR is preferably small, for example, preferably less than 60% by mass, more preferably less than 40% by mass, further preferably less than 30% by mass, further preferably less than 25% by mass, further preferably less than 20% by mass, from the viewpoint of suppressing temperature dependency of the rubber composition. A lower limit of the styrene content is not particularly limited, but it is usually about greater than 1% by mass, greater than 3% by mass, or greater than 5% by mass. Besides, the styrene content of the SBR is measured by the above-described measuring method.

A vinyl content of the SBR is preferably greater than 10 mol %, more preferably greater than 13 mol %, further preferably greater than 15 mol %, from the viewpoints of ensuring reactivity with silica, wet grip performance, rubber strength, and abrasion resistance. Moreover, the vinyl content of the SBR is preferably less than 50 mol %, more preferably less than 40 mol %, further preferably 30 mol % or less, from the viewpoints of prevention of increase in temperature dependency, elongation at break, and abrasion resistance. Besides, the vinyl content of the SBR (1,2-bond butadiene unit amount) is measured by the above-described measuring method.

A glass transition temperature (Tg) of an SBR is preferably less than −30° C. from the viewpoint of suppressing temperature dependency of the rubber composition. The Tg of the SBR is preferably less than −40° C., more preferably less than −50° C., further preferably less than −55° C. Moreover, the Tg is usually higher than −80° C., higher than −70° C., or higher than −65° C. Besides, the Tg of the SBR is measured by the above-described measuring method.

A weight-average molecular weight (Mw) of an SBR is preferably greater than 200,000, more preferably greater than 250,000, further preferably greater than 300,000, from the viewpoint of wet grip performance. Moreover, weight-average molecular weight is preferably less than 2,000,000, more preferably less than 1,800,000, further preferably less than 1,500,000, from the viewpoint of cross-linking uniformity. Besides, the weight-average molecular weight of the SBR is measured by the above-described measuring method.

A content of an SBR when compounded in the rubber component is preferably greater than 3% by mass, more preferably greater than 5% by mass, further preferably greater than 10% by mass, from the viewpoint of wet grip performance. On the other hand, the content of the SBR in the rubber component is preferably 20% by mass or less, more preferably 10% by mass or less, further preferably 5% by mass or less, from the viewpoint of abrasion resistance. Besides, the content of the SBR in the rubber component may be 0% by mass.

### <<IR-Based Rubber>>

As an IR-based rubber, for example, those common in the tire industry can be used, such as an isoprene rubber (IR), a natural rubber, and the like. Examples of the natural rubber include a non-reformed natural rubber (NR), as well as a refined natural rubber such as an epoxidized natural rubber (ENR), a hydrogenated natural rubber (HNR), a deproteinized natural rubber (DPNR), an ultra pure natural rubber, a grafted natural rubber, and the like. The isoprene-based rubber may be used alone, or two or more thereof may be used in combination.

The NR is not particularly limited, and those common in the tire industry can be used, examples of which include, for example, SIR20, RSS #3, TSR20, and the like.

A content of an IR-based rubber when compounded in the rubber component is preferably greater than 3% by mass, more preferably greater than 5% by mass, further preferably greater than 10% by mass, from the viewpoint of wet grip performance. On the other hand, the content of the IR-based rubber in the rubber component is preferably 20% by mass or less, more preferably 10% by mass or less, further preferably 5% by mass or less, from the viewpoint of abrasion resistance. Besides, the content of the IR-based rubber in the rubber component may be 0% by mass.

### <Filler>

The rubber composition relating to the present invention comprises 50 parts by mass or more of silica as a filler based on 100 parts by mass of the rubber component.

The rubber composition relating to the present invention can comprise carbon black as a filler besides silica. The rubber composition more preferably comprises silica and carbon black as fillers, and a filler may be one consisting of silica and carbon black.

### (Silica)

Silica is not particularly limited, and those common in the tire industry can be used, such as, for example, silica prepared by a dry process (anhydrous silica), silica prepared by a wet process (hydrous silica), and the like. Moreover, silica made from a biomass material (for example, an amorphous silica purified from rice husks) may be used, from the viewpoint of environmental load. Among them, hydrous silica prepared by a wet process is preferable from the reason that it has many silanol groups. Silica may be used alone, or two or more thereof may be used in combination.

Silica made from a biomass material can be obtained by, for example, burning rice husks to obtain rice husk ashes, extracting silicate from the rice husk ashes using a sodium hydroxide solution, generating silicon dioxide by reacting the silicate with sulfuric acid in the same manner as for a conventional wet silica, and filtering, washing with water, drying and pulverizing precipitates of the silicon dioxide. When silica is crystallized, it is insoluble in water, and silicic acid that is a component thereof cannot be used. By controlling a burning temperature and a burning time, crystallization of silica in rice husk ashes can be suppressed (JP 2009-2594 A, Akita Prefectural University Web Journal B/2019, vol. 6, p. 216-222, etc.). As an amorphous silica extracted from rice husks, those commercially available from Wilmar, etc. can be used.

A nitrogen adsorption specific surface area (N₂SA) of silica is preferably greater than 140 m²/g, more preferably greater than 150 m²/g, further preferably greater than 160 m2/g, further preferably 175 m²/g or more, from the viewpoints of fuel efficiency and abrasion resistance. Moreover, it is preferably less than 350 m²/g, more preferably less than 300 m²/g, further preferably less than 250 m²/g, from the viewpoints of fuel efficiency and processability. Besides, the N₂SA of silica is measured by the above-described measuring method.

An average primary particle size of silica is preferably greater than 10 nm, more preferably greater than 12 nm, further preferably greater than 14 nm. Moreover, the average primary particle size is preferably less than 26 nm, more preferably less than 24 nm, further preferably 22 nm or less. Besides, the average primary particle size of silica is measured by the above-described measuring method.

A content of silica based on 100 parts by mass of the rubber component is preferably greater than 70 parts by mass, more preferably 80 parts by mass or more, further preferably greater than 90 parts by mass, further preferably 100 parts by mass or more, from the viewpoint of wet grip performance. Moreover, it is preferably less than 200 parts by mass, more preferably less than 150 parts by mass, further preferably less than 130 parts by mass, from the viewpoint of abrasion resistance.

### (Carbon Black)

As carbon black, those common in the tire industry can be appropriately used, examples of which include, for example, GPF, FEF, HAF, ISAF, SAF, and the like. Moreover, in addition to the above-described carbon black, carbon black made from lignin or a recovered carbon black obtained by pyrolysis or the like from a product including carbon black such as a tire and the like may be used, from the viewpoint of life cycle assessment. Carbon black may be used alone, or two or more thereof may be used in combination.

A nitrogen adsorption specific surface area (N₂SA) of carbon black is preferably greater than 10 m²/g, more preferably greater than 30 m²/g, further preferably greater than 50 m²/g, from the viewpoint of reinforcing property. Moreover, it is preferably less than 200 m²/g, more preferably less than 175 m²/g, further preferably less than 150 m²/g, from the viewpoints of fuel efficiency and processability. Besides, the N₂SA of carbon black is measured by the above-described measuring method.

An average primary particle size of carbon black is preferably greater than 10 nm, more preferably greater than 12 nm, further preferably greater than 14 nm. Moreover, the average primary particle size is preferably less than 26 nm, more preferably less than 24 nm, further preferably 22 nm or less. Besides, the average primary particle size of carbon black is measured by the above-described measuring method.

A content of carbon black when compounded based on 100 parts by mass of the rubber component is preferably greater than 1 part by mass or more, more preferably greater than 3 parts by mass or more, further preferably 5 parts by mass or more, from the viewpoints of abrasion resistance and wet grip performance. Moreover, it is preferably less than 50 parts by mass, more preferably less than 40 parts by mass, further preferably 30 parts by mass or less, from the viewpoint of fuel efficiency.

When both silica and carbon black are compounded, a content of silica is preferably greater than that of carbon black from the viewpoint of a balance of fuel efficiency, wet grip performance, and abrasion resistance. A ratio of a content of silica to a total content of silica and carbon black is preferably greater than 80% by mass, more preferably greater than 90% by mass, further preferably greater than 95% by mass.

### (Other Fillers)

As fillers, other fillers may further be used in addition to carbon black and silica. Such a filler is not particularly limited, and, for example, any fillers conventionally and commonly used in the tire industry can be used such as aluminum hydroxide, alumina (aluminum oxide), calcium carbonate, magnesium sulfate, talc, clay, biochar (BIO CHAR), and the like. Other fillers may be used alone, or two or more thereof may be used in combination.

A total content of fillers based on 100 parts by mass of the rubber component is preferably greater than 40 parts by mass, more preferably greater than 60 parts by mass, further preferably greater than 80 parts by mass, from the viewpoint of abrasion resistance. Moreover, it is preferably less than 250 parts by mass, more preferably less than 200 parts by mass, further preferably less than 150 parts by mass, from the viewpoints of fuel efficiency and elongation at break.

### (Silane Coupling Agent)

Silica is preferably used in combination with a silane coupling agent. The silane coupling agent is not particularly limited, and any silane coupling agents conventionally used in combination with silica in the tire industry can be used, examples of which include, for example, thioester-based silane coupling agents such as 3-octanoylthio-1-propyltriethoxysilane, 3-hexanoylthio-1-propyltriethoxysilane, 3-octanoylthio-1-propyltrimethoxysilane, and the like; mercapto-based silane coupling agents such as those shown below in the following chemical formulae and the like; sulfide-based silane coupling agents such as bis(3-triethoxysilylpropyl) disulfide, bis(3-triethoxysilylpropyl) tetrasulfide, and the like; vinyl-based silane coupling agents such as vinyltriethoxysilane, vinyltrimethoxysilane, and the like; amino-based silane coupling agents such as 3-aminopropyltriethoxysilane, 3-aminopropyltrimethoxysilane, 3-(2-aminoethyl)aminopropyltriethoxysilane, and the like; glycydoxy-based silane coupling agents such as γ-glycidoxypropyltriethoxysilane, γ-glycidoxypropyltrimethoxysilane, and the like; nitro-based silane coupling agents such as 3-nitropropyltrimethoxysilane, 3-nitropropyltriethoxysilane, and the like; chloro-based silane coupling agents such as 3-chloropropyltrimethoxysilane, 3-chloropropyltriethoxysilane, and the like; and the like. Among them, thioester-based silane coupling agents and/or sulfide-based silane coupling agents are preferable. The silane coupling agent may be used alone, or two or more thereof may be used in combination.

It is preferable that the mercapto-based silane coupling agent is a compound represented by the following chemical formula (1) and/or a compound comprising a bond unit A represented by the following chemical formula (2) and a bond unit B represented by the following chemical formula (3).

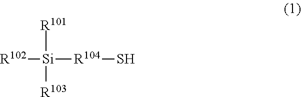

(wherein, R¹⁰¹, R¹⁰², and R¹⁰³ each independently represents an alkyl having 1 to 12 carbon atoms, an alkoxy having 1 to 12 carbon atoms, or a group represented by —O—(R¹¹¹—O)_{z}—R¹¹² (z pieces of R¹¹¹ each independently represents a divalent hydrocarbon group having 1 to 30 carbon atoms; R¹¹² represents an alkyl having 1 to 30 carbon atoms, an alkenyl having 2 to 30 carbon atoms, an aryl having 6 to 30 carbon atoms, or an aralkyl having 7 to 30 carbon atoms; and z represents an integer of 1 to 30); and R¹⁰⁴ represents an alkylene having 1 to 6 carbon atoms.)

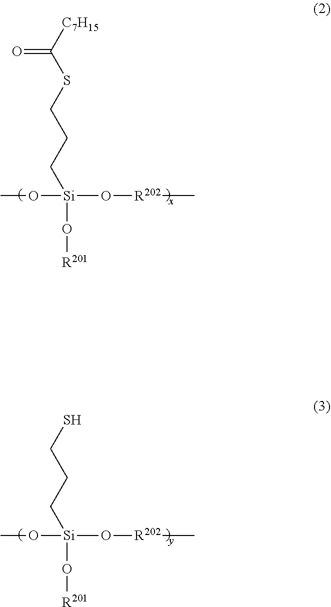

(wherein, x represents an integer of 0 or more; y represents an integer of 1 or more; R²⁰¹ represents hydrogen atom, or an alkyl having 1 to 30 carbon atoms, an alkenyl having 2 to 30 carbon atoms or an alkynyl having 2 to 30 carbon atoms optionally substituted with a halogen atom, hydroxyl or carboxyl; and R²⁰² represents an alkylene having 1 to 30 carbon atoms, an alkenylene having 2 to 30 carbon atoms, or an alkynylene having 2 to 30 carbon atoms; where R²⁰¹ and R²⁰² may together form a ring structure.)

Examples of the compound represented by the chemical formula (1) include, for example, 3-mercaptopropyltrimethoxysilane, 3-mercaptopropyltriethoxysilane, 2-mercaptoethyltrimethoxysilane, 2-mercaptoethyltriethoxysilane, a compound represented by the following chemical formula (4) (Si363 manufactured by Evonik Degussa GmbH), and the like. Among them, the compound represented by the following chemical formula (4) can be appropriately used. They may be used alone, or two or more thereof may be used in combination.

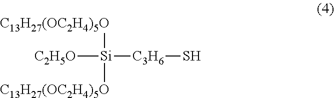

Examples of the compound comprising the bond unit A represented by the chemical formula (2) and the bond unit B represented by the chemical formula (3) include, for example, those manufactured and sold by Momentive Performance Materials, etc. They may be used alone, or two or more thereof may be used in combination.

A content of the silane coupling agent when compounded based on 100 parts by mass of the rubber component (a total amount of all of a plurality of silane coupling agents when used in combination) is preferably greater than 0.5 parts by mass, more preferably greater than 1.0 parts by mass, further preferably greater than 2.0 parts by mass, further preferably greater than 4.0 parts by mass, from the viewpoint of enhancing dispersibility of silica. Moreover, it is preferably less than 20 parts by mass, more preferably less than 12 parts by mass, further preferably less than 10 parts by mass, further preferably less than 9.0 parts by mass, from the viewpoint of preventing a decrease of abrasion resistance.

A content of the silane coupling agent based on 100 parts by mass of silica is preferably greater than 1.0 parts by mass, more preferably greater than 3.0 parts by mass, further preferably greater than 5.0 parts by mass, from the viewpoint of enhancing dispersibility of silica. Moreover, it is preferably less than 20 parts by mass, more preferably less than 15 parts by mass, further preferably less than 12 parts by mass, from the viewpoints of cost and processability.

### <Plasticizing Agent>

The rubber composition relating to the present invention preferably comprises a plasticizing agent. Examples of the plasticizing agent include, for example, a hydrocarbon resin, oil, a liquid rubber, an ester-based plasticizing agent, and the like.

### (Hydrocarbon Resin)

A hydrocarbon resin refers to a polymer having a skeleton formed of a hydrocarbon, which is solid at 25° C. The hydrocarbon resin may generally comprise an oxygen element derived from a carboxyl group, a hydroxyl group, coumarone, or the like. The hydrocarbon resin is not particularly limited, examples of which include a petroleum resin, a terpene-based resin, a rosin-based resin, a phenol-based resin, and the like, which are commonly used in the tire industry. As the hydrocarbon resin, for example, those commercially available from Maruzen Petrochemical Co., Ltd., Sumitomo Bakelite Co., Ltd., Yasuhara Chemical Co., Ltd., Tosoh Corporation, Rutgers Chemicals, BASF, Kraton Corporation, Eastman Chemical Company, Nitto Chemical Co., Ltd., Zibo Luhua Hongjin New Material Group Co., Ltd, Nippon Shokubai Co., Ltd., ENEOS Corporation, Arakawa Chemical Industries, Ltd., Taoka Chemical Co., Ltd., etc. can be used. The hydrocarbon resin may be used alone, or two or more thereof may be used in combination.

### <<Petroleum Resin>>

As a petroleum resin, a C5-based petroleum resin, an aromatic petroleum resin, a C5/C9-based petroleum resin, and the like can be used. The petroleum resin may be used alone, or two or more thereof may be used in combination.

A C5-based petroleum resin refers to a resin obtained by polymerizing a C5 fraction. Examples of the C5 fraction include, for example, a petroleum fraction having 4 to 5 carbon atoms such as cyclopentadiene, a pentene, a pentadiene, isoprene, and the like, and may be one obtained by hydrogenating or modifying them. As the C5-based petroleum resin, a dicyclopentadiene resin (DCPD resin) is appropriately used.

An aromatic petroleum resin refers to a resin obtained by polymerizing a C9 fraction, and may be hydrogenated or modified. Examples of the C9 fraction include, for example, a petroleum fraction having 8 to 10 carbon atoms such as vinyltoluene, alkylstyrene, indene, methyl indene, and the like. As specific examples of the aromatic petroleum resin, for example, a coumarone indene resin, a coumarone resin, an indene resin, and an aromatic vinyl-based resin are appropriately used.

As the aromatic vinyl-based resin, a homopolymer of α-methylstyrene or styrene or a copolymer of α-methylstyrene and styrene is preferable, and a copolymer of α-methylstyrene and styrene is more preferable, because it is economical, easy to process, and excellent in heat generation.

A C5/C9-based petroleum resin refers to a resin obtained by copolymerizing the C5 fraction and the C9 fraction, and may be hydrogenated or modified. Examples of the C5 fraction and the C9 fraction include the above-described petroleum fractions. As the C5-C9-based petroleum resin, for example, those commercially available from Tosoh Corporation, Zibo Luhua Hongjin New Material Group Co., Ltd, etc. can be appropriately used.

### <<Terpene-Based Resin>>

Examples of a terpene-based resin include a polyterpene resin consisting of at least one selected from terpene compounds such as α-pinene, β-pinene, limonene, a dipentene, and the like; an aromatic-modified terpene resin made from a terpene compound of the above-described terpene compounds and an aromatic compound; a terpene phenolic resin made from a terpene compound and a phenol-based compound; and those in which these terpene-based resins are hydrogenated (hydrogenated terpene-based resins). Examples of the aromatic compound used as a raw material for the aromatic-modified terpene resin include, for example, styrene, α-methylstyrene, vinyltoluene, divinyltoluene, and the like. Examples of the phenol-based compound used as a raw material for the terpene phenolic resin include, for example, phenol, bisphenol A, cresol, xylenol, and the like. The terpene-based resin may be used alone, or two or more thereof may be used in combination.

### <<Rosin-Based Resin>>

Example of a rosin-based resin include, but not particularly limited to, for example, a natural resin rosin and a rosin-modified resin obtained by modifying it by hydrogenation, disproportionation, dimerization, esterification, etc., and the like. The rosin-based resin may be used alone, or two or more thereof may be used in combination.

### <<Phenol-Based Resin>>

Examples of a phenol-based resin include, but not particularly limited to, a phenol formaldehyde resin, an alkylphenol formaldehyde resin, an alkylphenol acetylene resin, an oil-modified phenol formaldehyde resin, and the like. The phenol-based resin may be used alone, or two or more thereof may be used in combination.

### <<Softening Point>>

A softening point of the hydrocarbon resin is preferably higher than 60° C., more preferably higher than 70° C., further preferably higher than 80° C., from the viewpoint of wet grip performance. Moreover, it is preferably lower than 150° C., more preferably lower than 140° C., further preferably lower than 130° C., from the viewpoints of processability and improvement of dispersibility of a rubber component with a filler. Besides, the softening point is measured by the above-described measuring method.

### <<Glass Transition Temperature (Tg)>>

A Tg of the hydrocarbon resin is preferably 110° C. or lower, more preferably 105° C. or lower, further preferably 100° C. or lower, from the viewpoint of an excellent compatibility with the rubber component. Moreover, the Tg is preferably −35° C. or higher, more preferably 0° C. or higher, further preferably 30° C. or higher, from the viewpoint of an excellent compatibility with the rubber component. Besides, the Tg is measured by the above-described measuring method using a differential scanning calorimeter.

### <<Weight-Average Molecular Weight (Mw)>>

A Mw of the hydrocarbon resin is preferably greater than 500, more preferably greater than 600, further preferably greater than 650, from the viewpoints of less volatilization and a good grip performance. Moreover, the Mw is preferably less than 15000, more preferably less than 13000, further preferably less than 11000, from the viewpoint that the hydrocarbon resin easily entangles and less disentangles with a polymer and thus is excellent in dry grip performance. When the Mw is within the above-described ranges, a rubber composition to be obtained has an excellent processability and can have improved heat generation and elongation at break. Besides, the Mw is measured by the above-described measuring method.

### <<Content>>

The rubber composition relating to the present invention preferably comprises at least one type of hydrocarbon resin from the viewpoints of wet grip performance, etc., and in the rubber composition of the present invention, a content of the hydrocarbon resin in the rubber composition is preferably 5% by mass or more. A content of resin in the rubber composition is preferably greater than 7% by mass, more preferably greater than 10% by mass, further preferably greater than 12% by mass, further preferably greater than 15% by mass, further preferably greater than 25% by mass, further preferably greater than 35% by mass, most preferably greater than 45% by mass. Moreover, the content of resin in the rubber composition is preferably less than 100% by mass, more preferably less than 80% by mass, further preferably less than 60% by mass.

### (Oil)

Examples of oil include, for example, a process oil, vegetable fats and oils, animal fats and oils, and the like. Examples of the process oil include a paraffin-based process oil, a naphthene-based process oil, an aroma-based process oil, and the like. Moreover, as an environmental measure, a process oil having a low content of a polycyclic aromatic compound (PCA) can also be used. Examples of the process oil having a low content of a PCA include a mild extraction solvent (MES), a treated distillate aromatic extract (TDAE), a heavy naphthenic oil, and the like. Oil may be used alone, or two or more thereof may be used in combination.

A content of oil when compounded based on 100 parts by mass of the rubber component is preferably greater than 5 parts by mass, more preferably greater than 10 parts by mass, further preferably greater than 15 parts by mass, from the viewpoint of processability. Moreover, it is preferably less than 120 parts by mass, more preferably less than 80 parts by mass, further preferably less than 40 parts by mass, from the viewpoint of abrasion resistance. Besides, in the present specification, the content of oil also includes an amount of oil contained in an oil-extended rubber.

### (Liquid Rubber)

The liquid rubber is not particularly limited as long as it is a polymer in a liquid state at a normal temperature (25° C.), examples of which include, for example, a liquid butadiene rubber (a liquid BR), a liquid styrene-butadiene rubber (a liquid SBR), a liquid isoprene rubber (a liquid IR), a liquid styrene-isoprene rubber (a liquid SIR), a liquid farnesene rubber, and the like. The liquid rubber may be used alone, or two or more thereof may be used in combination.

A content of the liquid rubber when compounded based on 100 parts by mass of the rubber component is preferably greater than 1 part by mass, more preferably greater than 2 parts by mass, further preferably greater than 3 parts by mass, further preferably greater than 5 parts by mass. Moreover, the content of the liquid rubber is preferably less than 50 parts by mass, more preferably less than 40 parts by mass, further preferably less than 20 parts by mass.

### (Ester-Based Plasticizing Agent)

Examples of the ester-based plasticizing agent include, for example, dibutyl adipate (DBA), diisobutyl adipate (DIBA), dioctyl adipate (DOA), bis(2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. The ester-based plasticizing agent may be used alone, or two or more thereof may be used in combination.

### (Content of Plasticizing Agent)

A content of a plasticizing agent based on 100 parts by mass of the rubber component is preferably greater than 5 parts by mass, more preferably greater than 10 parts by mass, further preferably greater than 15 parts by mass, from the viewpoint of wet grip performance. Moreover, it is preferably less than 120 parts by mass, more preferably less than 80 parts by mass, further preferably less than 60 parts by mass, from the viewpoint of processability.

### (Other Compounding Agents)

The rubber composition relating to the present invention can appropriately comprise compounding agents conventionally and commonly used in the tire industry, for example, processing aid, zinc oxide, stearic acid, wax, an antioxidant, a vulcanizing agent, a vulcanization accelerator, and the like, in addition to the above-described components.

### (Processing Aid)

Examples of processing aid include, for example, a fatty acid metal salt, a fatty acid amide, an amide ester, a silica surface active agent, a fatty acid ester, a mixture of a fatty acid metal salt and an amide ester, a mixture of a fatty acid metal salt and a fatty acid amide, and the like. Processing aid may be used alone, or two or more thereof may be used in combination. As processing aid, for example, those commercially available from Schill+Seilacher GmbH, Performance Additives, etc. can be used.

A content of processing aid when compounded based on 100 parts by mass of the rubber component is preferably greater than 0.5 parts by mass, more preferably greater than 1 part by mass, further preferably greater than 1.5 parts by mass, from the viewpoint of exhibiting an effect of improving processability. Moreover, it is preferably less than 10 parts by mass, more preferably less than 8.0 parts by mass, further preferably less than 5.0 parts by mass, from the viewpoint of abrasion resistance and breaking strength.

### (Zinc Oxide)

A content of zinc oxide when compounded based on 100 parts by mass of the rubber component is preferably greater than 0.5 parts by mass, more preferably greater than 1.0 parts by mass, further preferably greater than 1.5 parts by mass, from the viewpoint of processability. Moreover, it is preferably less than 10 parts by mass, more preferably less than 7 parts by mass, further preferably less than 5 parts by mass, from the viewpoint of abrasion resistance.

### (Stearic Acid)

A content of stearic acid when compounded based on 100 parts by mass of the rubber component is preferably 0.5 parts by mass or more, more preferably 1.0 parts by mass or more, further preferably 1.5 parts by mass or more, from the viewpoint of processability. Moreover, it is preferably 10 parts by mass or less, more preferably 5.0 parts by mass or less, from the viewpoint of vulcanization rate.

### (Wax)

A content of wax when compounded based on 100 parts by mass of the rubber component is preferably greater than 0.5 parts by mass, more preferably greater than 1.0 parts by mass, further preferably greater than 1.3 parts by mass, from the viewpoint of weather resistance of a rubber. Moreover, it is preferably less than 10 parts by mass, more preferably less than 7.0 parts by mass, further preferably less than 5.0 parts by mass, from the viewpoint of preventing whitening of a tire due to bloom.

### (Antioxidant)

Examples of the antioxidant include, but not particularly limited to, for example, amine-based, quinoline-based, quinone-based, phenol-based and imidazole-based compounds, a carbamic acid metal salt, and the like, preferably, phenylenediamine-based antioxidants such as N-(1,3-dimethylbutyl)-N′-phenyl-p-phenylenediamine, N-isopropyl-N′-phenyl-p-phenylenediamine, N,N′-diphenyl-p-phenylenediamine, N,N′-di-2-naphthyl-p-phenylenediamine, N-cyclohexyl-N′-phenyl-p-phenylenediamine, and the like, and quinoline-based antioxidants such as 2,2,4-trimethyl-1,2-dihydroquinoline polymer, 6-ethoxy-2,2,4-trimethyl-1,2-dihydroquinoline, and the like. The antioxidant may be used alone, or two or more thereof may be used in combination.

A content of the antioxidant when compounded based on 100 parts by mass of the rubber component is preferably greater than 0.5 parts by mass, more preferably greater than 1.0 parts by mass, further preferably greater than 1.5 parts by mass, from the viewpoint of ozone crack resistance of a rubber. Moreover, it is preferably less than 10 parts by mass, more preferably less than 7 parts by mass, further preferably less than 5 parts by mass, from the viewpoints of abrasion resistance and wet grip performance.

### (Vulcanizing Agent)

Sulfur is appropriately used as a vulcanizing agent. As sulfur, a powdery sulfur, an oil processing sulfur, a precipitated sulfur, a colloidal sulfur, an insoluble sulfur, a highly dispersible sulfur, and the like can be used. The vulcanizing agent may be used alone, or two or more thereof may be used in combination.

A content of sulfur when compounded as a vulcanizing agent based on 100 parts by mass of the rubber component is preferably greater than 0.1 parts by mass, more preferably greater than 0.3 parts by mass, further preferably greater than 0.5 parts by mass, from the viewpoint of securing a sufficient vulcanization reaction. Moreover, it is preferably less than 5.0 parts by mass, more preferably less than 4.0 parts by mass, further preferably less than 3.0 parts by mass, from the viewpoint of preventing deterioration. Besides, a content of the vulcanizing agent when an oil-containing sulfur is used as the vulcanizing agent shall be a total content of pure sulfur comprised in the oil-containing sulfur.

Examples of vulcanizing agents other than sulfur include, for example, an alkylphenol-sulfur chloride condensate, sodium hexamethylene-1,6-bisthiosulfate dihydrate, 1,6-bis(N,N′-dibenzylthiocarbamoyldithio) hexane, and the like. As these vulcanizing agents other than sulfur, those commercially available from Taoka Chemical Co., Ltd., LANXESS, Flexsys, etc. can be used.

### (Vulcanization Accelerator)

Examples of the vulcanization accelerator include, for example, sulfenamide-based, thiazole-based, thiuram-based, thiourea-based, guanidine-based, dithiocarbamic acid-based, aldehyde-amine-based or aldehyde-ammonia-based, imidazoline-based, and xantate-based vulcanization accelerators, and the like. The vulcanization accelerator may be used alone, or two or more thereof may be used in combination.

Among them, one or more vulcanization accelerators selected from the group consisting of sulfenamide-based, guanidine-based, and thiazole-based vulcanization accelerators are preferably compounded, and the vulcanization accelerator more preferably consists of a sulfenamide-based vulcanization accelerator and a guanidine-based vulcanization accelerator.

Examples of the sulfenamide-based vulcanization accelerator include, for example, N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), and the like. Among them, N-cyclohexyl-2-benzothiazolylsulfenamide (CBS) is preferable.

Examples of the guanidine-based vulcanization accelerator include, for example, 1,3-diphenylguanidine (DPG), 1,3-di-o-tolylguanidine, 1-O-tolylbiguanide, di-o-tolylguanidine salt of dicatecholborate, 1,3-di-o-cumenylguanidine, 1,3-di-o-biphenylguanidine, 1,3-di-o-cumenyl-2-propionylguanidine, and the like. Among them, 1,3-diphenylguanidine (DPG) is preferable.

Examples of the thiazole-based vulcanization accelerator include, for example, 2-mercaptobenzothiazole, a cyclohexylamine salt of 2-mercaptobenzothiazole, di-2-benzothiazolyl disulfide, and the like. Among them, 2-mercaptobenzothiazole is preferable.

A content of the vulcanization accelerator when compounded based on 100 parts by mass of the rubber component is preferably greater than 1 part by mass, more preferably greater than 1.5 parts by mass, further preferably greater than 2 parts by mass. Moreover, the content of the vulcanization accelerator based on 100 parts by mass of the rubber component is preferably less than 8 parts by mass, more preferably less than 7 parts by mass, further preferably less than 6 parts by mass. When the content of the vulcanization accelerator is within the above-described ranges, breaking strength and elongation tend to be secured.

### [Production]

Any of the rubber compositions relating to the present invention can be produced by a known method. For example, it can be produced by kneading each of the above-described components using a rubber kneading apparatus such as an open roll, a closed type kneader (Bunbury mixer, kneader, etc.), and the like.

The kneading step includes, for example, a base kneading step of kneading compounding agents and additives other than vulcanizing agents and vulcanization accelerators and a final kneading (F kneading) step of adding vulcanizing agents and vulcanization accelerators to the kneaded product obtained by the base kneading step and kneading them. Furthermore, the base kneading step can be divided into a plurality of steps, if desired.

A kneading condition is not particularly limited. Examples of kneading include, for example, in the base kneading step, a method of kneading at a discharge temperature of 150 to 170° C. for 3 to 10 minutes, and in the final kneading step, a method of kneading at 70 to 110° C. for 1 to 5 minutes.

The pneumatic tire of the present invention can be manufactured by a usual method using the above-described unvulcanized rubber composition. That is, the pneumatic tire of the present invention can be manufactured by extruding an unvulcanized rubber composition into a shape of a predetermined tread with an extruder equipped with a mouthpiece having a predetermined shape, attaching it together with other tire members on a tire forming machine, and molding them by a usual method, to form an unvulcanized tire, followed by heating and pressurizing this unvulcanized tire in a vulcanizing machine. A vulcanization condition is not particularly limited. Examples of vulcanization include, for example, a method of vulcanizing at 150 to 200° C. for 10 to 30 minutes.

### [Application]

The pneumatic tire of the present invention can be used for any application, for example, as a tire for a passenger car, a tire for a large passenger car, a tire for a light truck, a tire for a large SUV, a racing tire, or a motorcycle tire. Among them, a tire for a passenger car and a tire for a light truck are preferable. Here, the tire for a passenger car is a tire on the premise that it is mounted on a car running on four wheels and refers to one having a maximum load capacity of 1,000 kg or less under the JATMA standard, while the tire for a light truck refers to one having a maximum load capacity of less than 1,400 kg.

Moreover, the tire of the present invention can be used as a summer tire, a winter tire, or a studless tire for each of the above-described tires.

### EXAMPLES

Although the present invention will be described based on Examples, it is not limited to Examples.

### [Various Chemicals]

Various chemicals used in Examples and Comparative examples are collectively shown below.
NR: TSR20
SBR1: SLR6430 manufactured by Trinseo PLC (S-SBR, styrene content: 40% by mass, vinyl bond amount: 24 mol %, Tg: −30° C., Mw: 1,010,000, oil-extended product comprising 37.5 parts by mass of oil content based on 100 parts by mass of rubber component)
SBR2: Styrene-butadiene rubber synthesized in Production example 1 below (modified S-SBR, styrene content: 20% by mass, vinyl content: 20 mol %, Tg: −60° C., Mw: 800,000)
BR1: Ubepol BR (Registered Trademark) 150B manufactured by Ube Industries, Ltd. (vinyl content: 1.5 mol %, cis content: 97 mol %, Tg: −108° C., Mw: 440,000)
BR2: ASAPRENE N103 manufactured by Asahi Kasei Corporation (modified BR whose terminal is modified with a mixture of tetraglycidyl-1,3-bisaminomethylcyclohexane and its oligomer component, vinyl content: 12 mol %, cis content: 36% by mass, Tg: −90° C., Mw: 550,000)
CB (Carbon black): Show Black N134 manufactured by Cabot Japan K.K. (N₂SA: 148 m²/g, average primary particle size: 18 nm)
Silica: Ultrasil (Registered Trademark) VN3 manufactured by Evonik Degussa GmbH (N₂SA: 175 m²/g, average primary particle size: 18 nm)
Coupling agent (Silane coupling agent): Si266 manufactured by Evonik Degussa GmbH (bis(3-triethoxysilylpropyl) disulfide)
Oil: VivaTec 500 manufactured by H&R Group (TDAE oil)
Hydrocarbon resin 1: Sylvatraxx 4401 manufactured by Kraton Corporation (α-methylstyrene resin (copolymer of styrene and α-methylstyrene), Mw: 700, softening point: 85° C., SP value: 9.1)
Hydrocarbon resin 2: PR395 manufactured by Exxon Mobil Corporation (C5/C9-based resin, Mw: 880, softening point: 117.8° C., Tg: 68° C.)
Zinc oxide: Zinc oxide No. 2 manufactured by Mitsui Mining & Smelting Co., Ltd.
Stearic acid: Bead stearic acid “CAMELLIA” manufactured by NOF CORPORATION
Wax: SUNNOC N manufactured by Ouchi Shinko Chemical Industry Co., Ltd.
Antioxidant 1: Antigen 6C manufactured by Sumitomo Chemical Co., Ltd. (6PPD, N-(1,3-dimethylbutyl)-N′-phenyl-p-phenylenediamine)
Antioxidant 2: Nocrac 224 manufactured by Ouchi Shinko Chemical Industry Co., Ltd. (TMQ, 2,2,4-trimethyl-1,2-dihydroquinoline polymer)
Sulfur: Powdered sulfur manufactured by Karuizawa Sulfur Co, Ltd.
Vulcanization accelerator 1: Nocceler CZ manufactured by Ouchi Shinko Chemical Industry Co., Ltd. (CBS, N-cyclohexyl-2-benzothiazolylsulfenamide)
Vulcanization accelerator 2: Nocceler D manufactured by Ouchi Shinko Chemical Industry Co., Ltd. (DPG, 1,3-diphenylguanidine)

### PRODUCTION EXAMPLE

### Production Example 1: Synthesis of SBR2

A ratio of styrene and 1,3-butadiene is adjusted so that a styrene content is 20% by mass, in a target product. Cyclohexane, tetrahydrofuran, styrene, and 1,3-butadiene are charged into an autoclave reactor subjected to nitrogen purge. After adjusting the temperature of the contents in the reactor to 20° C., n-butyllithium is added to initiate polymerization. Polymerization is performed under an adiabatic condition, and when a polymerization conversion rate reaches 99%, 1,3-butadiene is added, and after further polymerization, methyltriethoxysilane is added as a modifying agent to perform a modification reaction. After completion of the reaction, 2,6-di-tert-butyl-p-cresol is added. Next, the mixture is subjected to removal of solvent by a steam stripping and dried by a heat roll whose temperature is adjusted to 110° C. to obtain SBR2.

### Examples and Comparative Examples

According to the compounding formulations shown in each Table, using a 1.7 L closed Banbury mixer, all chemicals other than sulfur and vulcanization accelerators are kneaded until reaching a discharge temperature at 150° C. to 160° C. for 1 to 10 minutes to obtain a kneaded product. Next, using a twin-screw open roll, sulfur and vulcanization accelerators are added to the obtained kneaded product, and the mixture is kneaded for 4 minutes until the temperature reaches 105° C. to obtain an unvulcanized rubber composition. The obtained unvulcanized rubber composition is molded into a shape of a predetermined tread according to each Table and attached together with other tire members, preparing an unvulcanized tire, followed by press-vulcanized under a condition at 170° C. for 12 minutes to obtain each test tire (Tire 1: 225/60R16 98H, Tire 2: 275/55R20 117T XL).

A tread surface of each test tire has at least circumferential main grooves and lateral grooves. The number of circumferential main grooves is three, one of which passes on a tire center line, and the remaining two are installed at equally spaced positions on the outer side in the tire width direction from the main grooves that pass on the tire center line. Besides, the tread surface does not have any small holes, circumferential narrow grooves, and widened circumferential grooves.

### <Evaluation>

For each test tire, results measured by the following methods are also described in the corresponding columns of Tables below.

### (Land Ratio)

For each test tire, a total ground-contacting area and an effective ground-contacting area as defined above are determined, calculating a land ratio (%).

### (Thickness of Tread)

For each test tire, a thickness of a tread as defined above is measured.

### (Wet Grip Performance)

Each test tire is mounted to all wheels of a vehicle (Tire 1: domestic FF vehicle, displacement of 2000 cc; Tire 2: domestic 4 WD vehicle, displacement of 3000 cc), which is made run on a test course of a wet asphalt road surface at a speed of 80 km/h, and grip performance (wet grip performance) during the running is evaluated by 20 test drivers with a score of 1 to 5, calculating a total score. The results are indicated as indexes with the reference Comparative example being as 100. The results show that the higher the index is, the more excellent the steering stability during running is and the more excellent the wet grip performance is.

### (Abrasion Resistance)

Each test tire is mounted to all wheels of a vehicle (Tire 1: domestic FF vehicle, displacement of 2000 cc; Tire 2: domestic 4 WD vehicle, displacement of 3000 cc), which is made run 20,000 km on a test course on an asphalt road surface, measuring a reducing amount of a thickness of a tread from a starting time of running. The results are indicated as indexes with the reference Comparative example being as 100. The results show that the larger the index is, the smaller the reducing amount is and the more excellent the abrasion resistance is.

TABLE 1-1
(Tire 1: 225/60R16 98H)

| Example | | | | | | | |
|---|---|---|---|---|---|---|---|
| 1-1 | 1-2 | 1-3 | 1-4 | 1-5 | 1-6 | 1-7 | 1-8 |

Compounding amount (part by mass)

| | | | | | | | | |
|---|---|---|---|---|---|---|---|---|
| NR | 20 | — | 20 | 20 | 20 | — | 20 | 20 |
| SBR1 | — | — | — | — | — | — | — | — |
| SBR2 | — | — | — | — | — | 20 | — | — |
| BR1 | 80 | 100 | 80 | 40 | — | — | — | — |
| BR2 | — | — | — | 40 | 80 | 80 | 80 | 80 |
| (Extending oil) | (0) | (0) | (0) | (0) | (0) | (0) | (0) | (0) |
| CB | 5 | 5 | 5 | 5 | 5 | 5 | 5 | 5 |
| Silica | 80 | 80 | 80 | 80 | 80 | 80 | 80 | 80 |
| Coupling agent | 6.4 | 6.4 | 6.4 | 6.4 | 6.4 | 6.4 | 6.4 | 6.4 |
| Oil | 15 | 15 | 15 | 15 | 15 | 15 | 15 | 5 |
| Hydrocarbon resin 1 | 20 | 20 | 20 | 20 | 20 | 20 | — | 30 |
| Hydrocarbon resin 2 | — | — | — | — | — | — | 20 | — |
| Zinc oxide | 3 | 3 | 3 | 3 | 3 | 3 | 3 | 3 |
| Stearic acid | 3 | 3 | 3 | 3 | 3 | 3 | 3 | 3 |
| Wax | 1.5 | 1.5 | 1.5 | 1.5 | 1.5 | 1.5 | 1.5 | 1.5 |
| Antioxidant 1 | 2 | 2 | 2 | 2 | 2 | 2 | 2 | 2 |
| Antioxidant 2 | 1 | 1 | 1 | 1 | 1 | 1 | 1 | 1 |
| Sulfur | 1.5 | 1.5 | 1.5 | 1.5 | 1.5 | 1.5 | 1.5 | 1.5 |
| Vulcanization accelerator | 2 | 2 | 2 | 2 | 2 | 2 | 2 | 2 |
| 1 | | | | | | | | |
| Vulcanization accelerator | 1.8 | 1.8 | 1.8 | 1.8 | 1.8 | 1.8 | 1.8 | 1.8 |
| 2 | | | | | | | | |
| Content of BR (% by mass) | 80 | 100 | 80 | 80 | 80 | 80 | 80 | 80 |
| (A_{BR}) | | | | | | | | |
| Land ratio (%) (L) | 62 | 58 | 67 | 62 | 62 | 62 | 62 | 62 |
| Thickness of tread (mm) | 11 | 11 | 11 | 11 | 11 | 11 | 11 | 11 |
| (T) | | | | | | | | |
| Content of hydrocarbon | 8.3 | 8.3 | 8.3 | 8.3 | 8.3 | 8.3 | 8.3 | 12.4 |
| resin (% by mass) | | | | | | | | |
| A_{BR} × L | 4960 | 5800 | 5360 | 4960 | 4960 | 4960 | 4960 | 4960 |
| (A_{BR}/T) × L | 451 | 527 | 487 | 451 | 451 | 451 | 451 | 451 |
| Wet grip performance | 106 | 104 | 106 | 108 | 110 | 112 | 112 | 112 |
| Abrasion resistance | 110 | 110 | 114 | 109 | 108 | 109 | 108 | 109 |
| Overall performance | 216 | 214 | 220 | 217 | 218 | 221 | 220 | 221 |

| Example | | | | | |
|---|---|---|---|---|---|
| 1-9 | 1-10 | 1-11 | 1-12 | 1-13 | 1-14 |

Compounding amount (part by mass)

| | | | | | | |
|---|---|---|---|---|---|---|
| NR | 20 | — | — | — | — | 13 |
| SBR1 | — | — | — | — | — | — |
| SBR2 | — | — | — | — | — | — |
| BR1 | — | — | — | — | — | — |
| BR2 | 80 | 100 | 100 | 100 | 100 | 87 |
| (Extending oil) | (0) | (0) | (0) | (0) | (0) | (0) |
| CB | 5 | 5 | 5 | 5 | 5 | 5 |
| Silica | 100 | 100 | 100 | 100 | 100 | 100 |
| Coupling agent | 8 | 8 | 8 | 8 | 8 | 8 |
| Oil | 25 | 25 | 25 | 5 | 5 | 5 |
| Hydrocarbon resin 1 | 30 | 30 | 30 | 50 | 50 | 50 |
| Hydrocarbon resin 2 | — | — | — | — | — | — |
| Zinc oxide | 3 | 3 | 3 | 3 | 3 | 3 |
| Stearic acid | 3 | 3 | 3 | 3 | 3 | 3 |
| Wax | 1.5 | 1.5 | 1.5 | 1.5 | 1.5 | 1.5 |
| Antioxidant 1 | 2 | 2 | 2 | 2 | 2 | 2 |
| Antioxidant 2 | 1 | 1 | 1 | 1 | 1 | 1 |
| Sulfur | 1.5 | 1.5 | 1.5 | 1.5 | 1.5 | 1.5 |
| Vulcanization accelerator | 2 | 2 | 2 | 2 | 2 | 2 |
| 1 | | | | | | |
| Vulcanization accelerator | 1.8 | 1.8 | 1.8 | 1.8 | 1.8 | 1.8 |
| 2 | | | | | | |
| Content of BR (% by mass) | 80 | 100 | 100 | 100 | 100 | 87 |
| (A_{BR}) | | | | | | |
| Land ratio (%) (L) | 62 | 58 | 62 | 62 | 62 | 62 |
| Thickness of tread (mm) | 11 | 11 | 11 | 11 | 9 | 11 |
| (T) | | | | | | |
| Content of hydrocarbon | 10.6 | 10.6 | 10.6 | 17.6 | 17.6 | 17.6 |
| resin (% by mass) | | | | | | |
| A_{BR} × L | 4960 | 5800 | 6200 | 6200 | 6200 | 5394 |
| (A_{BR}/T) × L | 451 | 527 | 564 | 564 | 689 | 490 |
| Wet grip performance | 116 | 114 | 118 | 122 | 124 | 124 |
| Abrasion resistance | 108 | 110 | 112 | 112 | 115 | 111 |
| Overall performance | 224 | 224 | 230 | 234 | 239 | 235 |

TABLE 1-2
(Tire 1: 225/60R16 98H)

| Comparative example | | | | | |
|---|---|---|---|---|---|
| 1-1 | 1-2 | 1-3 | 1-4 | 1-5 | 1-6 |

Compounding amount (part by mass)

| | | | | | | |
|---|---|---|---|---|---|---|
| NR | — | — | — | — | 20 | — |
| SBR1 | 96.25 | 68.75 | 96.25 | 96.25 | — | 68.75 |
| SBR2 | — | — | — | — | — | — |
| BR1 | 30 | 50 | 30 | — | 80 | 50 |
| BR2 | — | — | — | 30 | — | — |
| (Extending oil) | (26.25) | (18.75) | (26.25) | (26.25) | (0) | (18.75) |
| CB | 5 | 5 | 5 | 5 | 55 | 5 |
| Silica | 80 | 80 | 80 | 80 | 30 | 80 |
| Coupling agent | 6.4 | 6.4 | 6.4 | 6.4 | 6.4 | 6.4 |
| Oil | 10 | 17 | 10 | 10 | 10 | 10 |
| Hydrocarbon resin 1 | — | — | — | — | — | 10 |
| Hydrocarbon resin 2 | — | — | — | — | — | — |
| Zinc oxide | 3 | 3 | 3 | 3 | 3 | 3 |
| Stearic acid | 3 | 3 | 3 | 3 | 3 | 3 |
| Wax | 1.5 | 1.5 | 1.5 | 1.5 | 1.5 | 1.5 |
| Antioxidant 1 | 2 | 2 | 2 | 2 | 2 | 2 |
| Antioxidant 2 | 1 | 1 | 1 | 1 | 1 | 1 |
| Sulfur | 1.5 | 1.5 | 1.5 | 1.5 | 1.5 | 1.5 |
| Vulcanization accelerator 1 | 2 | 2 | 2 | 2 | 2 | 2 |
| Vulcanization accelerator 2 | 1.8 | 1.8 | 1.8 | 1.8 | 1.8 | 1.8 |
| Content of BR (% by mass) (A_{BR}) | 30 | 50 | 30 | 30 | 80 | 50 |
| Land ratio (%) (L) | 58 | 58 | 62 | 58 | 62 | 58 |
| Thickness of tread (mm) (T) | 11 | 11 | 11 | 11 | 11 | 11 |
| Content of hydrocarbon resin (% by mass) | 0 | 0 | 0 | 0 | 0 | 4.1 |
| A_{BR} × L | 1740 | 2900 | 1860 | 1740 | 4960 | 2900 |
| (A_{BR}/T) × L | 158 | 264 | 169 | 158 | 422 | 264 |
| Wet grip performance | 100 | 94 | 100 | 102 | 90 | 96 |
| Abrasion resistance | 100 | 105 | 102 | 99 | 112 | 105 |
| Overall performance | 200 | 199 | 202 | 201 | 202 | 201 |

TABLE 2-1
(Tire 2: 275/55R20 117T XL)

| Example | | | | | | | |
|---|---|---|---|---|---|---|---|
| 2-1 | 2-2 | 2-3 | 2-4 | 2-5 | 2-6 | 2-7 | 2-8 |

Compounding amount (part by mass)

| | | | | | | | | |
|---|---|---|---|---|---|---|---|---|
| NR | 20 | — | 20 | 20 | 20 | — | 20 | 20 |
| SBR1 | — | — | — | — | — | — | — | — |
| SBR2 | — | — | — | — | — | 20 | — | — |
| BR1 | 80 | 100 | 80 | 40 | — | — | — | — |
| BR2 | — | — | — | 40 | 80 | 80 | 80 | 80 |
| (Extending oil) | (0) | (0) | (0) | (0) | (0) | (0) | (0) | (0) |
| CB | 5 | 5 | 5 | 5 | 5 | 5 | 5 | 5 |
| Silica | 80 | 80 | 80 | 80 | 80 | 80 | 80 | 80 |
| Coupling agent | 6.4 | 6.4 | 6.4 | 6.4 | 6.4 | 6.4 | 6.4 | 6.4 |
| Oil | 15 | 15 | 15 | 15 | 15 | 15 | 15 | 5 |
| Hydrocarbon resin 1 | 20 | 20 | 20 | 20 | 20 | 20 | — | 30 |
| Hydrocarbon resin 2 | — | — | — | — | — | — | 20 | — |
| Zinc oxide | 3 | 3 | 3 | 3 | 3 | 3 | 3 | 3 |
| Stearic acid | 3 | 3 | 3 | 3 | 3 | 3 | 3 | 3 |
| Wax | 1.5 | 1.5 | 1.5 | 1.5 | 1.5 | 1.5 | 1.5 | 1.5 |
| Antioxidant 1 | 2 | 2 | 2 | 2 | 2 | 2 | 2 | 2 |
| Antioxidant 2 | 1 | 1 | 1 | 1 | 1 | 1 | 1 | 1 |
| Sulfur | 1.5 | 1.5 | 1.5 | 1.5 | 1.5 | 1.5 | 1.5 | 1.5 |
| Vulcanization accelerator | 2 | 2 | 2 | 2 | 2 | 2 | 2 | 2 |
| 1 | | | | | | | | |
| Vulcanization accelerator | 1.8 | 1.8 | 1.8 | 1.8 | 1.8 | 1.8 | 1.8 | 1.8 |
| 2 | | | | | | | | |
| Content of BR (% by mass) | 80 | 100 | 80 | 80 | 80 | 80 | 80 | 80 |
| (A_{BR}) | | | | | | | | |
| Land ratio (%) (L) | 62 | 58 | 67 | 62 | 62 | 62 | 62 | 62 |
| Thickness of tread (mm) | 15 | 15 | 15 | 15 | 15 | 15 | 15 | 15 |
| (T) | | | | | | | | |
| Content of hydrocarbon | 8.3 | 8.3 | 8.3 | 8.3 | 8.3 | 8.3 | 8.3 | 12.4 |
| resin (% by mass) | | | | | | | | |
| A_{BR} × L | 4960 | 5800 | 5360 | 4960 | 4960 | 4960 | 4960 | 4960 |
| (A_{BR}/T) × L | 331 | 387 | 357 | 331 | 331 | 331 | 331 | 331 |
| Wet grip performance | 104 | 102 | 104 | 106 | 108 | 110 | 110 | 110 |
| Abrasion resistance | 108 | 108 | 112 | 107 | 106 | 107 | 106 | 107 |
| Overall performance | 212 | 210 | 216 | 213 | 214 | 217 | 216 | 217 |

| Example | | | | | |
|---|---|---|---|---|---|
| 2-9 | 2-10 | 2-11 | 2-12 | 2-13 | 2-14 |

Compounding amount (part by mass)

| | | | | | | |
|---|---|---|---|---|---|---|
| NR | 20 | — | — | — | — | 13 |
| SBR1 | — | — | — | — | — | — |
| SBR2 | — | — | — | — | — | — |
| BR1 | — | — | — | — | — | — |
| BR2 | 80 | 100 | 100 | 100 | 100 | 87 |
| (Extending oil) | (0) | (0) | (0) | (0) | (0) | (0) |
| CB | 5 | 5 | 5 | 5 | 5 | 5 |
| Silica | 100 | 100 | 100 | 100 | 100 | 100 |
| Coupling agent | 8 | 8 | 8 | 8 | 8 | 8 |
| Oil | 25 | 25 | 25 | 5 | 5 | 5 |
| Hydrocarbon resin 1 | 30 | 30 | 30 | 50 | 50 | 50 |
| Hydrocarbon resin 2 | — | — | — | — | — | — |
| Zinc oxide | 3 | 3 | 3 | 3 | 3 | 3 |
| Stearic acid | 3 | 3 | 3 | 3 | 3 | 3 |
| Wax | 1.5 | 1.5 | 1.5 | 1.5 | 1.5 | 1.5 |
| Antioxidant 1 | 2 | 2 | 2 | 2 | 2 | 2 |
| Antioxidant 2 | 1 | 1 | 1 | 1 | 1 | 1 |
| Sulfur | 1.5 | 1.5 | 1.5 | 1.5 | 1.5 | 1.5 |
| Vulcanization accelerator | 2 | 2 | 2 | 2 | 2 | 2 |
| 1 | | | | | | |
| Vulcanization accelerator | 2.2 | 2.2 | 2.2 | 2.2 | 2.2 | 2.2 |
| 2 | | | | | | |
| Content of BR (% by mass) | 80 | 100 | 100 | 100 | 100 | 87 |
| (A_{BR}) | | | | | | |
| Land ratio (%) (L) | 62 | 58 | 62 | 62 | 62 | 62 |
| Thickness of tread (mm) | 15 | 15 | 15 | 15 | 13 | 15 |
| (T) | | | | | | |
| Content of hydrocarbon | 10.6 | 10.6 | 10.6 | 17.6 | 17.6 | 17.6 |
| resin (% by mass) | | | | | | |
| A_{BR} × L | 4960 | 5800 | 6200 | 6200 | 6200 | 5394 |
| (A_{BR}/T) × L | 331 | 387 | 413 | 413 | 477 | 360 |
| Wet grip performance | 114 | 112 | 116 | 120 | 122 | 122 |
| Abrasion resistance | 106 | 108 | 111 | 111 | 115 | 109 |
| Overall performance | 220 | 220 | 227 | 231 | 237 | 231 |

TABLE 2-2
(Tire 2: 275/55R20 117T XL)

| Comparative example | | | | | |
|---|---|---|---|---|---|
| 2-1 | 2-2 | 2-3 | 2-4 | 2-5 | 2-6 |

Compounding amount (part by mass)

| | | | | | | |
|---|---|---|---|---|---|---|
| NR | — | — | — | — | 20 | — |
| SBR1 | 96.25 | 68.75 | 96.25 | 96.25 | — | 68.75 |
| SBR2 | — | — | — | — | — | — |
| BR1 | 30 | 50 | 30 | — | 80 | 50 |
| BR2 | — | — | — | 30 | — | — |
| (Extending oil) | (26.25) | (18.75) | (26.25) | (26.25) | (0) | (18.75) |
| CB | 5 | 5 | 5 | 5 | 55 | 5 |
| Silica | 80 | 80 | 80 | 80 | 30 | 80 |
| Coupling agent | 6.4 | 6.4 | 6.4 | 6.4 | 6.4 | 6.4 |
| Oil | 10 | 17 | 10 | 10 | 10 | 10 |
| Hydrocarbon resin 1 | — | — | — | — | — | 10 |
| Hydrocarbon resin 2 | — | — | — | — | — | — |
| Zinc oxide | 3 | 3 | 3 | 3 | 3 | 3 |
| Stearic acid | 3 | 3 | 3 | 3 | 3 | 3 |
| Wax | 1.5 | 1.5 | 1.5 | 1.5 | 1.5 | 1.5 |
| Antioxidant 1 | 2 | 2 | 2 | 2 | 2 | 2 |
| Antioxidant 2 | 1 | 1 | 1 | 1 | 1 | 1 |
| Sulfur | 1.5 | 1.5 | 1.5 | 1.5 | 1.5 | 1.5 |
| Vulcanization accelerator 1 | 2 | 2 | 2 | 2 | 2 | 2 |
| Vulcanization accelerator 2 | 1.8 | 1.8 | 1.8 | 1.8 | 1.8 | 1.8 |
| Content of BR (% by mass) (ABR) | 30 | 50 | 30 | 30 | 80 | 50 |
| Land ratio (%) (L) | 58 | 58 | 62 | 58 | 62 | 58 |
| Thickness of tread (mm) (T) | 15 | 15 | 15 | 15 | 15 | 15 |
| Content of hydrocarbon resin (% by mass) | 0 | 0 | 0 | 0 | 0 | 4.1 |
| A_{BR} × L | 1740 | 2900 | 1860 | 1740 | 4960 | 2900 |
| (A_{BR}/T) × L | 116 | 193 | 124 | 116 | 331 | 193 |
| Wet grip performance | 100 | 94 | 100 | 102 | 90 | 96 |
| Abrasion resistance | 100 | 105 | 102 | 99 | 112 | 105 |
| Overall performance | 200 | 199 | 202 | 201 | 202 | 201 |

### Embodiments

Preferred embodiments are shown below.

[1] A pneumatic tire comprising a tread part,
wherein the tread part is composed of a rubber composition comprising 50 parts by mass or more, preferably 70 parts by mass or more, more preferably 80 parts by mass or more, further preferably 90 parts by mass or more of silica, based on 100 parts by mass of a rubber component,
wherein the rubber component comprises 80% by mass or more, preferably greater than 83% by mass of a butadiene rubber, and
wherein, when A_{BR} represents a content, in % by mass, of the butadiene rubber in the rubber component and L represents a land ratio, in %, of a tread surface of the tread part, A_{BR} and L satisfy the following inequality:

$${A}_{BR} \times L > 4800. \qquad ( 1 )$$

[2] The pneumatic tire of [1], wherein, when T represents a thickness, in mm, of the tread part, A_{BR}, L, and T satisfy the following inequality:

$$( {A}_{BR} / T ) \times L > 400 \qquad ( 2 )$$

where the right side of the inequality (2) is preferably 450, more preferably 500, further preferably 550, further preferably 600, further preferably 650.

[3] The pneumatic tire of [1] or [2], wherein the rubber composition comprises at least one type of hydrocarbon resin, and wherein a content of the hydrocarbon resin in the rubber composition is 5% by mass or more, preferably greater than 6% by mass, more preferably greater than 7% by mass, further preferably greater than 10% by mass, further preferably greater than 12% by mass, and it is preferably less than 30% by mass, more preferably less than 25% by mass, further preferably less than 20% by mass.

[4] The pneumatic tire of any one of [1] to [3], wherein a content of the silica based on 100 parts by mass of the rubber component is 100 parts by mass or more.

[5] The pneumatic tire of any one of [1] to [4], wherein the butadiene rubber comprises a modified butadiene rubber.

[6] The pneumatic tire of any one of [1] to [5], wherein the right side of the inequality (1) is 4950, preferably 5300, more preferably 5700.

[7] The pneumatic tire of any one of [1] to [5], wherein the right side of the inequality (1) is 6000.

[8] The pneumatic tire of any one of [1] to [7], wherein the content, A_{BR}, of the butadiene rubber in the rubber component is greater than 85% by mass, preferably greater than 90% by mass, and it is preferably less than 95% by mass.

[9] The pneumatic tire of any one of [1] to [8], wherein the rubber component further comprises a styrene-butadiene rubber having a styrene content of less than 25% by mass, preferably less than 20% by mass or an isoprene-based rubber.

[10] The pneumatic tire of any one of [1] to [9],
wherein the tread surface has two or more circumferential main grooves extending in a tire circumferential direction and land parts partitioned off by the circumferential main grooves, and
wherein, when a pair of land parts located on an outermost side in a tire width direction of the land parts are defined as shoulder land parts, the shoulder land parts have one or more small holes each having an opening area of greater than 0.1 mm² and less than 15 mm², preferably greater than 0.5 mm² and less than 10 mm², more preferably greater than 0.5 mm² and less than 7.0 mm², further preferably greater than 1.0 mm² and less than 5.0 mm².

[11] The pneumatic tire of any one of [1] to [10],
wherein the tread surface has two or more circumferential main grooves extending in a tire circumferential direction and land parts partitioned off by the circumferential main grooves, and
wherein, when a pair of land parts located on an outermost side in a tire width direction of the land parts are defined as shoulder land parts, the shoulder land parts have at least one or more circumferential narrow grooves.

[12] The pneumatic tire of any one of [1] to [11], wherein the tread surface has widened circumferential grooves whose groove width widens towards an inner side in a tire radial direction.

[13] The pneumatic tire of [12], wherein the widened circumferential groove is present on a land part located on a tire center line, or on a land part closest to the tire center line when a circumferential main groove is present on the tire center line.

### REFERENCE SIGNS LIST

CL. Tire center line
T. Thickness of tread
Te. Tread grounding end
W. Tire width direction
C. Tire circumferential direction
1. Tire
2. Circumferential main groove
3. Land part
4. Small hole
5. Circumferential narrow groove
6. Widened circumferential groove

What is claimed is:

1. A pneumatic tire comprising a tread part,
wherein the tread part is composed of a rubber composition comprising 50 parts by mass or more of silica based on 100 parts by mass of a rubber component,
wherein the rubber component comprises 80% by mass or more of a butadiene rubber, and
wherein, when A_{BR} represents a content, in % by mass, of the butadiene rubber in the rubber component and L represents a land ratio, in %, of a tread surface of the tread part, A_{BR} and L satisfy the following inequality:
$${A}_{BR} \times L > 4800. \qquad ( 1 )$$

2. The pneumatic tire of claim 1, wherein, when T represents a thickness, in mm, of the tread part, A_{BR}, L, and T satisfy the following inequality:
$$( {A}_{BR} / T ) \times L > 400. \qquad ( 2 )$$

3. The pneumatic tire of claim 1,
wherein the rubber composition comprises at least one type of hydrocarbon resin, and
wherein a content of the hydrocarbon resin in the rubber composition is 5% by mass or more.

4. The pneumatic tire of claim 1, wherein a content of the silica based on 100 parts by mass of the rubber component is 100 parts by mass or more.

5. The pneumatic tire of claim 1, wherein the butadiene rubber comprises a modified butadiene rubber.

6. The pneumatic tire of claim 1, wherein the right side of the inequality (1) is 4950.

7. The pneumatic tire of claim 1, wherein the right side of the inequality (1) is 6000.

8. The pneumatic tire of claim 1, wherein the content, A_{BR}, of the butadiene rubber in the rubber component is greater than 85% by mass.

9. The pneumatic tire of claim 1, wherein the rubber component further comprises a styrene-butadiene rubber having a styrene content of less than 25% by mass or an isoprene-based rubber.

10. The pneumatic tire of claim 1,
wherein the tread surface has two or more circumferential main grooves extending in a tire circumferential direction and land parts partitioned off by the circumferential main grooves, and
wherein, when a pair of land parts located on an outermost side in a tire width direction of the land parts are defined as shoulder land parts, the shoulder land parts have one or more small holes each having an opening area of greater than 0.1 mm² and less than 15 mm².

11. The pneumatic tire of claim 1,
wherein the tread surface has two or more circumferential main grooves extending in a tire circumferential direction and land parts partitioned off by the circumferential main grooves, and
wherein, when a pair of land parts located on an outermost side in a tire width direction of the land parts are defined as shoulder land parts, the shoulder land parts have at least one or more circumferential narrow grooves.

12. The pneumatic tire of claim 1, wherein the tread surface has widened circumferential grooves whose groove width widens towards an inner side in a tire radial direction.

13. The pneumatic tire of claim 12, wherein the widened circumferential groove is present on a land part located on a tire center line, or on a land part closest to the tire center line when a circumferential main groove is present on the tire center line.
